(19) United States
(12) Patent Application Publication
(10) Pub. No.: US 2015/0088613 A1
(43) Pub. Date: Mar. 26, 2015

(54) SYSTEMS, METHODS, AND COMPUTER PROGRAM PRODUCTS FOR MANAGING FUEL COSTS

(71) Applicant: Comdata Network, Inc., Brentwood, TN (US)

(72) Inventors: Thomas L. Pierce, JR., Brentwood, TN (US); Randall K. Morgan, Brentwood, TN (US); Charles T. Joseph, Franklin, TN (US)

(73) Assignee: Comdata Network, Inc., Brentwood, TN (US)

(21) Appl. No.: 14/033,965

(22) Filed: Sep. 23, 2013

(51) Int. Cl. G06Q 30/02

(52) U.S. Cl. CPC G06Q 30/0206
USPC 705/7.35

(57) ABSTRACT

Systems, methods, and computer program products are provided for managing fuel costs. Fuel-related data, including a request for authorization of a fuel transaction, is received from a fuel-related data source via a communications network. A fuel-related score is computed based on the fuel-related data and a predetermined weighting factor. The fuel-related score is presented through a user interface. In one example aspect, a fuel-related notification is generated for the fuel transaction based on the fuel-related score and a predetermined alert rule stored in an alert rule database. The predetermined alert rule is one of a plurality of sets of predetermined alert rules stored in association with a plurality of corresponding fleets, in another example.

### BACKGROUND

1. Field

Example aspects described herein relate generally to cost management, and more particularly to systems, methods, and computer program products for managing fuel costs.

2. Related Art

An ever increasing number of materials and goods are being transported throughout the country, for example, by trucking service providers (also referred to herein as “fleets”), who are being subjected to rising and unpredictable fuel costs. Fuel costs may vary widely based on various factors, such as, for example, a geographical area in which fuel is purchased, a fuel provider (also referred to herein as “merchants”) from which fuel is purchased, and/or whether any pricing agreement has been negotiated between a trucking service provider and a fuel provider. Thus, managing fuel costs can be challenging for trucking service providers, particularly for service providers who employ many truck drivers and/or serve an expansive geographical area.

Given the foregoing, it would be beneficial to enable trucking service providers to manage fuel costs based on meaningful, accurate, and up-to-date fuel-related data centrally aggregated from various sources. It would also be beneficial to enable trucking service providers to analyze, in a timely manner, how individual fuel purchases factor into overall fuel expenses.

### SUMMARY

The example embodiments herein provide systems, methods, and computer program products for managing fuel costs. Fuel-related data, including a request for authorization of a fuel transaction, is received from a fuel-related data source via a communications network. A fuel-related score is computed based on the fuel-related data and a predetermined weighting factor. The fuel-related score is presented through a user interface.

In accordance with one example aspect herein, the computing of the fuel-related score includes (1) identifying, based on the fuel-related data, a geographical location of the fuel transaction; (2) identifying, based on the geographical location of the fuel transaction, a plurality of nearby alternative fuel provider locations; (3) retrieving, from a database, fuel-related data associated with the plurality of nearby alternative fuel provider locations; and (4) computing the fuel-related score based on the fuel-related data associated with the plurality of nearby alternative fuel provider locations.

The predetermined weighting factor, in one example, includes any one or a combination of a price-related weighting factor and/or a non-price-related weighting factor. The predetermined weighting factor is one of a plurality of predetermined weighting factors stored in association with a corresponding fleet, in another example.

In one example herein, the method further comprises a step of generating a fuel-related notification for the fuel transaction, based on the fuel-related score and a predetermined alert rule stored in an alert rule database. The predetermined alert rule, in another example, is one of a plurality of sets of predetermined alert rules stored in association with a plurality of corresponding fleets.

In accordance with some example aspects herein, the method further comprises a step of presenting, via the user interface, any one or a combination of a list of notable transactions, a ranking of a plurality of drivers, and a ranking of a plurality of fuel provider locations.

In another example herein, the method further comprises aggregating, from a plurality of fuel-related data sources via the communications network, a plurality of fuel-related data associated with any one or a combination of a plurality of fuel providers, a plurality of geographical locations, and a plurality of drivers; and presenting, via the user interface, a comparison of the aggregated fuel-related data.

In a further example, the method includes (1) matching, in a database, the transaction to a fleet and a merchant; and (2) retrieving, from the database, pricing agreement information associated with the fleet and the merchant; and the fuel-related score is computed based on the pricing agreement information.

### BRIEF DESCRIPTION OF THE DRAWINGS

The features and advantages of the example embodiments presented herein will become more apparent from the detailed description set forth below when taken in conjunction with the following drawings.

FIG. 1 is a diagram of an exemplary system for managing fuel costs, in accordance with various example embodiments herein.

FIG. 2 is a diagram further representing an exemplary system for managing fuel costs, in accordance with various example embodiments herein.

FIG. 3 shows an exemplary procedure for managing fuel costs, in accordance with an example embodiment herein.

FIG. 4 shows a representative goals management dashboard interface, in accordance with an example embodiment herein.

FIG. 5 shows an exemplary procedure for generating a fuel-related score, in accordance with an example embodiment herein.

FIG. 6 shows representative data elements that may be employed to generate a fuel-related score, in accordance with an example embodiment herein.

FIG. 7 shows an exemplary procedure for providing a fuel cost alert, in accordance with an example embodiment herein.

FIG. 8 shows a representative interface for providing a fuel cost alert, in accordance with an example embodiment herein.

FIG. 9 shows a representative fuel cost console interface, in accordance with an example embodiment herein.

FIG. 10 shows another view of a representative fuel cost console interface, in accordance with an example embodiment herein.

FIG. 11 shows a further view of a representative fuel cost console interface, in accordance with an example embodiment herein.

FIG. 12 shows exemplary navigation options that may be available via a fuel cost console interface, in accordance with an example embodiment herein.

FIG. 13 shows an exemplary customer selection navigation option that may be available via a fuel cost console interface, in accordance with an example embodiment herein.

FIG. 14 is an exemplary notable transactions interface that may be employed in a fuel cost console interface to show information relating to new transactions, in accordance with an example embodiment herein.

FIG. 15 is an exemplary notable transactions interface that may be employed in a fuel cost console interface to show information relating to old transactions, in accordance with an example embodiment herein.

FIG. 16 is an exemplary notable transactions interface that may be employed in a fuel cost console interface to show information relating to high scoring transactions, in accordance with an example embodiment herein.

FIG. 17 is an exemplary notable transactions interface that may be employed in a fuel cost console interface to show information relating to low scoring transactions, in accordance with an example embodiment herein.

FIG. 18 is an exemplary driver ranking interface that may be employed in a fuel cost console interface to show information relating to low saving drivers, in accordance with an example embodiment herein.

FIG. 19 is an exemplary driver ranking interface that may be employed in a fuel cost console interface to show information relating to high saving drivers, in accordance with an example embodiment herein.

FIG. 20 is an exemplary driver ranking interface that may be employed in a fuel cost console interface to show information relating to high scoring drivers, in accordance with an example embodiment herein.

FIG. 21 is an exemplary driver ranking interface that may be employed in a fuel cost console interface to show information relating to low scoring drivers, in accordance with an example embodiment herein.

FIG. 22 is an exemplary location ranking interface that may be employed in a fuel cost console interface to show information relating to most popular fueling locations, in accordance with an example embodiment herein.

FIG. 23 is an exemplary location ranking interface that may be employed in a fuel cost console interface to show information relating to least popular fueling locations, in accordance with an example embodiment herein.

FIG. 24 is an exemplary location ranking interface that may be employed in a fuel cost console interface to show information relating to high savings fueling locations, in accordance with an example embodiment herein.

FIG. 25 is an exemplary location ranking interface that may be employed in a fuel cost console interface to show information relating to low savings fueling locations, in accordance with an example embodiment herein.

FIG. 26 shows a representative fuel cost analytics interface, in accordance with an example embodiment herein.

FIG. 27 shows another representative fuel cost analytics interface, in accordance with an example embodiment herein.

FIG. 28 shows an exemplary view of an interface that may be employed in a fuel cost analytics interface to illustrate opportunities relating to trucking service provider chains, in accordance with an example embodiment herein.

FIG. 29 shows an exemplary chart that may be employed in a fuel cost analytics interface to illustrate opportunities relating to trucking service provider chains, in accordance with an example embodiment herein.

FIG. 30 shows an exemplary view of an interface that may be employed in a fuel cost analytics interface to illustrate geography-related opportunities, in accordance with an example embodiment herein.

FIG. 31 shows an exemplary chart that may be employed in a fuel cost analytics interface to illustrate geography-related opportunities, in accordance with an example embodiment herein.

FIG. 32 shows an exemplary view of an interface that may be employed in a fuel cost analytics interface to illustrate driver-related opportunities, in accordance with an example embodiment herein.

FIG. 33 shows an exemplary chart that may be employed in a fuel cost analytics interface to illustrate driver-related opportunities, in accordance with an example embodiment herein.

FIG. 34 shows an exemplary chart that may be employed to illustrate relative driver performance, in accordance with an example embodiment herein.

FIG. 35 is a block diagram of a general and/or special purpose computer that may be employed in accordance with various example embodiments herein.

### DETAILED DESCRIPTION

### I. Overview

The term “truck” may be used herein generally to refer to any type of motor vehicle used for transporting goods, materials, and/or other items. Example types of trucks may include a tractor-trailer, a cargo truck, a car, a van, and/or any other type of motor vehicle. In accordance with various example aspects herein, trucks may be powered by any type of fuel, such as, for example, the types of fuel described below.

The term “fuel” may be used herein generally to refer to any source of energy that may be used by a motor vehicle. Example types of fuel include gasoline, diesel fuel, propane, hydrogen, biofuel, electricity, and/or any other type of energy source.

The term “fuel-related data” may be used herein generally to refer to any data that relates to fuel (defined above). Example types of fuel-related data include, but are not limited to, data relating to fuel purchase transactions, customers, truck drivers, account numbers of payment products used for fuel purchases, and/or other types of data relating to fuel transactions.

Presented herein are novel and inventive systems, methods, and computer program products for managing fuel costs. In accordance with some aspects described herein, systems, methods, and computer program products are provided that enable trucking service providers to manage fuel costs based on meaningful, accurate, and up-to-date fuel-related data centrally aggregated from various sources.

Some example aspects herein enable trucking service providers to analyze, in a timely manner, how individual fuel purchases factor into overall fuel expenses, for example, taking into account various factors, such as a geographical area in which fuel is purchased, a fuel provider from which fuel is purchased, and/or whether any pricing agreement has been negotiated between a trucking service provider and a fuel provider.

### II. System

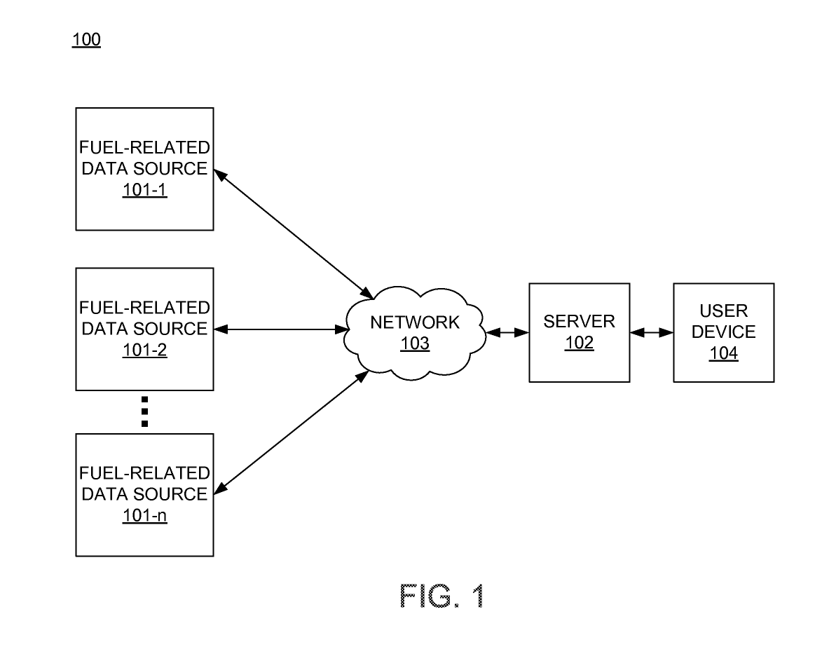

FIG. 1 is a diagram of an exemplary system 100 for managing fuel costs, in accordance with various example embodiments herein. The system 100 includes a server 102 that is communicatively coupled to a plurality of fuel-related data sources 101-1, 101-2 . . . 101-n (sometimes referred to herein collectively or individually as “101”) by way of a communications network 103. The communications network 103 may be a proprietary payment network, a virtual private network (VPN), a network using Hypertext Transfer Protocol (HTTP) standards, and/or another type of network. The server 102 is also communicatively coupled to a user device 104, such as a personal computer, a mobile communication device, a tablet computer, and/or another type of user device.

As described in further detail below, in accordance with various example embodiments herein, the server 102 operates by aggregating fuel-related data from the fuel-related data sources 101 via the network 103, processing the aggregated fuel-related data, and providing an application, by way of the user device 104, that enables a user to manage fuel costs taking into account the processed, aggregated fuel-related data. The application may include various functional modules, such as, for example, a console module and analytics/opportunity analyzer module(s).

The console module (also referred to herein as a fuel cost console), in one example embodiment, serves as a portal by which a user may view, in real-time or pseudo-real-time, a scoreboard of fuel-related data, such as fuel-related scores, for a particular time period (e.g., a particular business day). The analytics and/or opportunity analyzer module(s), in one example, enable a user to generate reports, comparisons against benchmarks, execute what-if scenarios, view exceptions and/or statistics relating to previous fuel purchases. The application and/or the modules included therein, in whole or in part, may be hosted by the server 102 (e.g., a web-based application) or may be hosted by the user device 104 (e.g., a local application).

In one example embodiment herein, the fuel-related data sources 101 provide fuel-related data to the server 102 by way of the network 103, in response to a user (e.g., a truck driver) initiating and/or completing a fuel purchase transaction using a proprietary payment product, such as a credit card, at a fuel provider.

In another example embodiment herein, sets of fleet preferences (e.g., notification preferences, scoring preferences, weighting preferences, and/or the like) are aggregated and stored in a memory or database included in, or coupled to, the server 102 for each of a plurality of fleets. The sets of fleet preferences are aggregated (e.g., periodically, automatically, or manually) by way of messages communicated to the server 102 from fleet systems (e.g., fuel-related data sources 101 of each fleet) via the communication network 103. This enables notifications to be provided (block 304, described below) for each of the plurality of fleets in a manner that is tailored to the preferences of the particular fleet.

In another example aspect herein, pricing agreement information relating to pre-negotiated agreements between merchants and fleets (e.g., discount pricing, discount conditions, discount time frame, discount location, and/or the like) is aggregated and stored in the memory or database included in, or coupled to, the server 102 for each of a plurality of fleets and/or merchants. The pricing agreement information is aggregated (e.g., periodically, automatically, or manually) by way of messages communicated to the server 102 from fleet systems and/or merchant systems (e.g., fuel-related data sources 101 of each fleet or each merchant) via the communication network 103. This enables scoring to be generated (block 303, described below) for each of a plurality of fleets while taking into account any contracts that the fleet may have pre-negotiated with merchants. By aggregating and storing fleet preferences and pricing agreement information, fleets may be provided, in realtime or pseudo-realtime, with meaningful and up-to-date information that they deem relevant and/or important regarding driver behavior, thus enabling the fleet to manage fuel costs by, for example, causing a timely change in driver behavior.

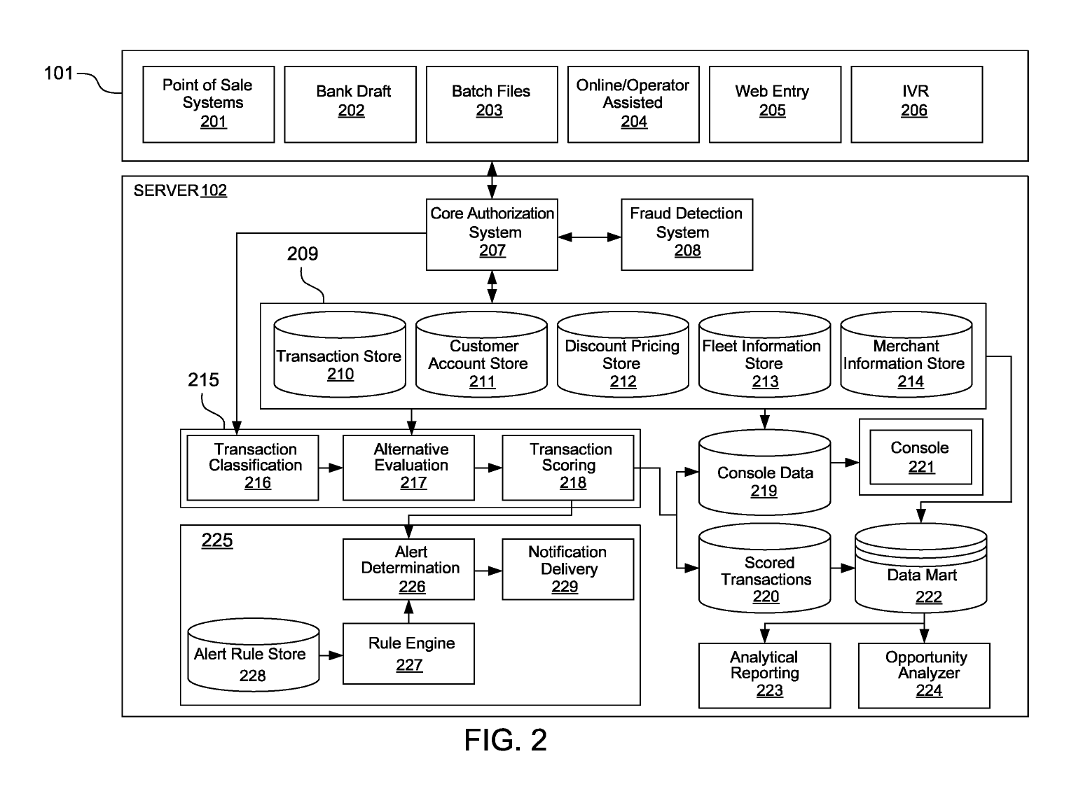

FIG. 2 is a diagram that, in some example embodiments herein, further represents various aspects of the system 100 for managing fuel costs. The functionality of various components shown in FIG. 2 will be described briefly in connection with FIG. 2, and in further detail below in connection with other ones of the figures. As shown in FIG. 2, example fuel-related data sources 101 include, without limitation, a point-of-sale system 201, a bank draft 202, a batch file 203, an online and/or operator assisted transaction 204, a web entry 205, an interactive voice response (IVR) system 206, and/or the like.

The server 102 includes various functional modules, such as a core authorization system 207, a fraud detection system 208, a database module 209, a scoring module 215, an alert module 225. The core authentication system 207 operates by executing authorization algorithms to authorize fuel purchase transaction requests received from one or more of the fuel-related data sources 101. The core authentication system 207 also communicates with the fraud detection system 208 that executes algorithms to detect, deny, and/or report fraudulent transaction requests.

The scoring module 215 executes algorithms to generate fuel-related scores based on the fuel-related data received from the fuel-related data sources 101, various types of data stored in the database module 209, and/or other types of data (e.g., transaction classification data, etc.). Exemplary types of data stored in the database module 209 include, without limitation, transaction data 210, customer account data 211, discount pricing data 212, fleet data 213, and/or merchant data 214.

The transaction data 210 includes historical transactional data that, in one example, is derived from any one or a combination of the data stores 211 through 214 or from another source such as, for example, any one or a combination of the fuel related data sources 101. Exemplary types of transaction data 210 include, without limitation, a date and time of a transaction; location information for a transactions, such as a merchant identifier and/or accompanying uniquely identifiable information; fleet specific information, such as a fleet account identifier; a customer identifier; a driver identifier; a card identifier; an amount of gallons of fuel purchased; a retail (e.g., pump) fuel price; discount/rebate information; and/or the like.

The customer account data 211 includes information that uniquely identifies accounts and corresponding account details. Exemplary types of customer account data 211 include, without limitation, a customer account identifier, a customer account name, security features/settings, and/or the like.

The discount pricing data 212 includes discount pricing components that may be used in connection with transactions. Exemplary types of discount pricing data 212 include, without limitation, a start date and/or an end date for a discount price offering, a location associated with a discount, a rack price, a discount type (e.g., cost plus, cost minus), and/or the like.

The fleet data 213 works in connection with the customer account data 211 and includes fleet vehicle information, fleet system preferences and/or setup information, fleet driver information, fleet payment card information, fleet user information, fleet preferences regarding transaction scoring and/or notifications, and/or the like.

The merchant data 214 includes information about merchants, such as, for example, a merchant name, a merchant type, a merchant address, coordinates (e.g., latitude and longitude) of a merchant location, a merchant identifier, agreement information that relates to agreements (e.g., pricing agreements) or contracts that a merchant has in place with one or more fleets, customers, or other entities, an identifier of an acquirer associated with a merchant, an identifier of an acceptor associated with the merchant, a terminal identifier, information about amenities offered by a particular merchant location, and/or the like. As described above, merchants may have pre-negotiated pricing agreements or contracts in place with one or more fleets, customers, or other entities. In one example embodiment, the merchant data 214 is periodically updated to include the latest such agreements. In this way, up-to-date and accurate fleet/merchant-specific pricing may be employed in scoring computations to provide a user with an efficient means of viewing and acting on fuel spending patterns.

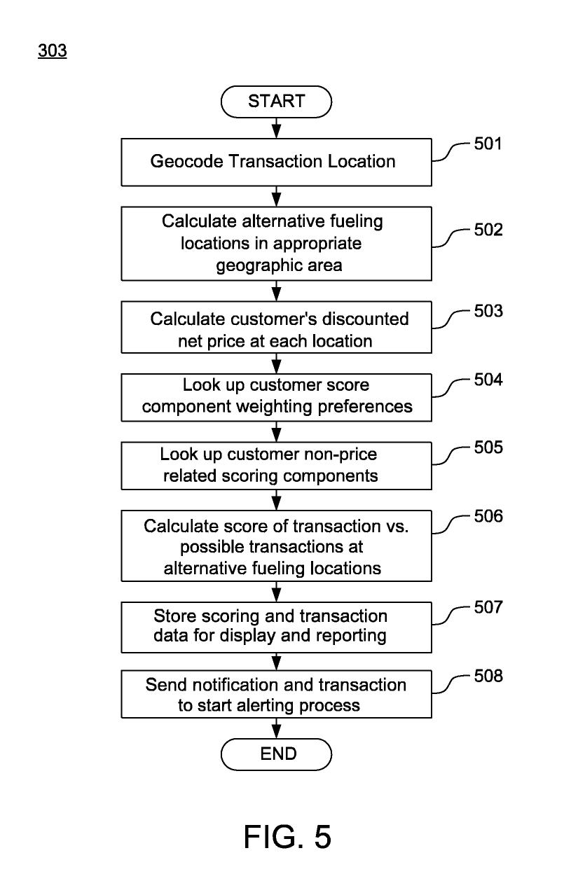

The scoring module 215 includes a transaction classification module 216, an alternative evaluation module 217, and a transaction scoring module 218 that, in some example aspects herein, are employed to generate the fuel-related scores. In particular, the transaction classification module 216 classifies fuel transactions based on various criteria, such as a geographical location from which the transaction request originated (sometimes referred to herein as geocoding). The alternative evaluation module 217 identifies alternative fuel providers that are located within a predetermined distance from the geographical area from which the transaction request originated (e.g., as determined by the transaction classification module 216). The transaction scoring module 218 computes a fuel-related score based on various criteria, for example, as described in further detail below in connection with FIG. 5.

In one example embodiment, the scoring module 215 stores the computed fuel-related score in a console database 219, from which the fuel-related score may be retrieved by a console application 221 that a user may interact with to manage fuel costs.

In general, and as described below in further detail, the console application 221 uses real-time fuel-related data and/or analytics to track, score, compare and report fuel-related transaction data for customers. In one example embodiment, fuel transactions are scored based on the actual price per gallon, taking into consideration any fleet specific discounts and rebates. Using data collected across an enterprise enables the console application 221 to score fuel transactions at a fuel service station, and/or at fleet or driver levels within defined highway segments. In another example aspect transactions may be geocoded and placed on a fleet-specific custom interactive map. Fleet managers may also be sent notifications (e.g., text and email messages) anytime a purchase is made below their custom score threshold.

In another example embodiment herein, the scoring module 215 stores the computed fuel-related score in a scored transactions database 220 for use at a later time in connection with analytics and/or opportunity analysis. For example, fuel-related scores may be communicated from the scored transactions database 220 to a data mart 222 database, from which historical fuel-related scores may be retrieved by an analytical reporting application 223 and/or an opportunity analyzer application 224 that a user may interact with to analyze and/or manage fuel costs based on various historical criteria. It should be understood that, although the analytical reporting application 223 and the opportunity analyzer application 224 are shown as separate components in FIG. 2, this example should not be construed as limiting. Example embodiments where the analytical reporting application 223 and the opportunity analyzer application 224 are combined into a single component are contemplated and are within the scope of the present invention.

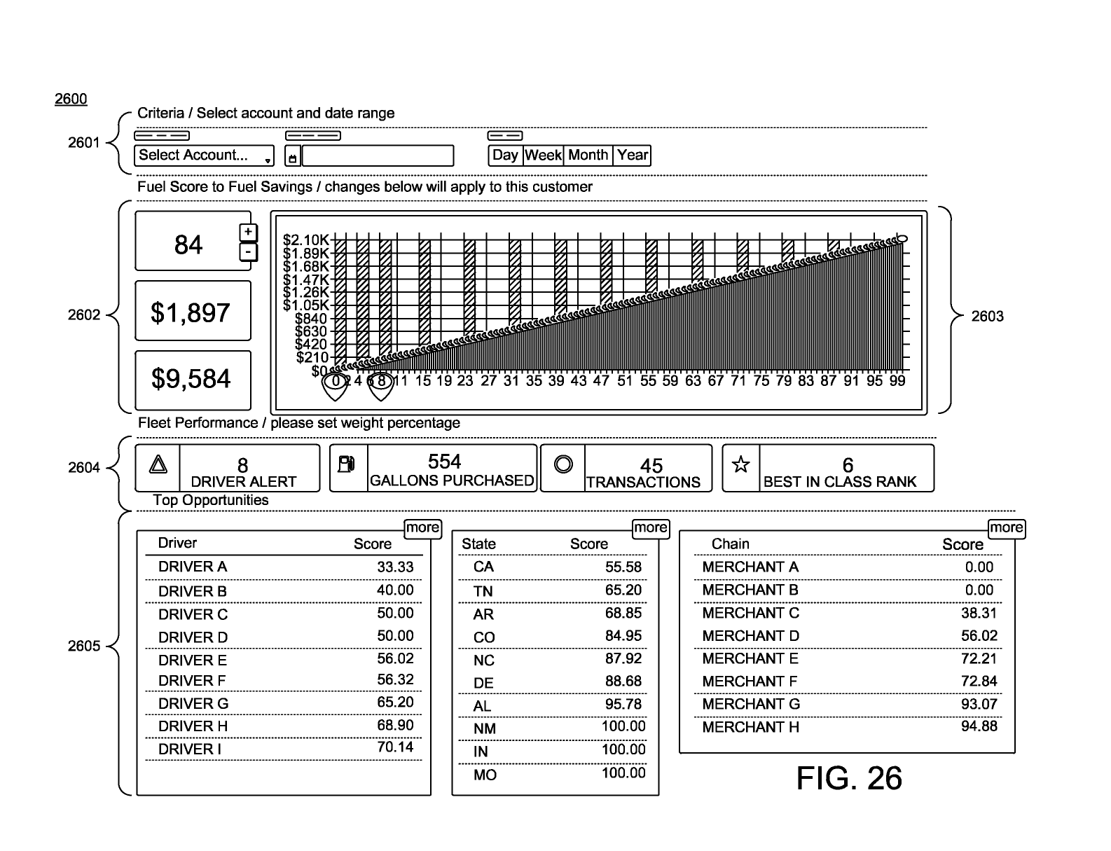

In general, and as described below in further detail in connection with FIGS. 26 through 34, the opportunity analyzer application 224 provides fleet managers with visibility into the purchase behavior of one or more fleets. Using advanced analytics the fleet's transactional information may be transformed and aggregated to show a holistic view of scored purchases over time. The opportunity analyzer application 224 enables users to interactively adjust their score, allowing them to better understand and quantify overall opportunities for additional savings. Additionally, users are able to easily view total alerts, transactions, gallons of fuel purchased, amounts of dollars spent on fuel purchases, how their fleet and drivers rank in comparison to other fleets, and top opportunities for improvement by driver, state, and chain.

The server 102 also includes an alert module 225 that generates and provides alerts based on various criteria, such as the fuel-related score generated by the transaction scoring module 218, the fuel-related data received from the fuel-related data sources 101, and/or other criteria. The alert module 225 includes an alert determination module 226 that, in some example aspects herein, determines, based on rules stored in an alert rule database 228 and/or generated by the rule engine 227, whether any fuel-related notifications are warranted for a particular fuel transaction. In one example embodiment, a user may configure an alert rule and store it in the database 228 for future use. If the alert determination module 226 determines that a fuel-related notification is warranted for a particular fuel transaction, then the alert determination module 226 identifies any notification preference(s) and/or notification template(s), for example, that may be stored in the alert rule database 228, regarding how the fuel-related notification is to be provided and generates the fuel-related notification according to the notification preference(s). The alert determination module 226 generates the fuel-related notification according to the notification preference(s). Example ways in which the fuel-related notification may be provided include, without limitation, an email communication, a short message service (SMS) communication, a pre-recorded telephone communication, and/or the like.

### III. Procedure

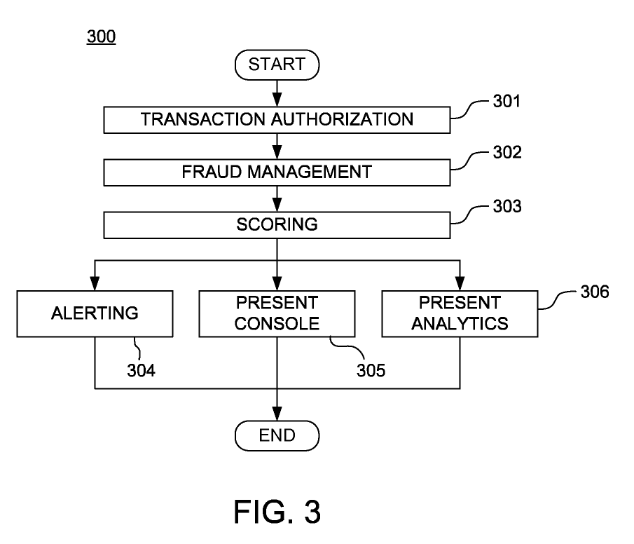

Having described an exemplary system 100 for managing fuel costs, reference will now be made to FIG. 3, which shows an exemplary procedure 300 for managing fuel costs that may be carried out by one or more components of the above-described system 100, in accordance with an example embodiment herein.

At block 301, after receiving fuel-related data, such as a fuel purchase transaction request, from the fuel-related data sources 101, the core authentication system 207 executes one or more authorization algorithms for authorizing the fuel purchase transaction request.

At block 302, the core authentication system 207 communicates the fuel-related data to the fraud detection system 208 and the fraud detection system 208 executes one or more algorithms to determine whether the transaction request is fraudulent. In one example embodiment, if the transaction is determined to be fraudulent the fraud detection system 208 denies and/or reports the transaction request as being fraudulent.

In one example embodiment, the fraud detection system 208 employs advanced analytics to identify patterns and anomalies across drivers and payment products (e.g., credit cards) in a fleet. By configuring alerts, fuel managers can be sent text message or email alerts that a fraudulent transaction is underway while the driver is still at the pump. Fuel managers can pause or terminate the transaction, thus limiting the fleet's exposure.

At block 303, and as described above in the context of FIG. 2, the scoring module 215 executes one or more algorithms to generate one or more fuel-related scores based on various criteria, such as the fuel-related data received from the fuel-related data sources 101, various types of data stored in the database module 209, and/or other types of data (e.g., transaction classification data, etc.). An example procedure that may be executed at block 303 to generate one or more fuel-related scores will be described below in connection with FIG. 5.

After block 303, the procedure 300 may proceed to any one or a combination of blocks 304, 305, and 306, based on a predetermined user preference, a user selection, a system configuration, and/or any other criteria. In one example, the functionality corresponding to block 304, block 305, and/or block 306 may be implemented sequentially or in parallel.

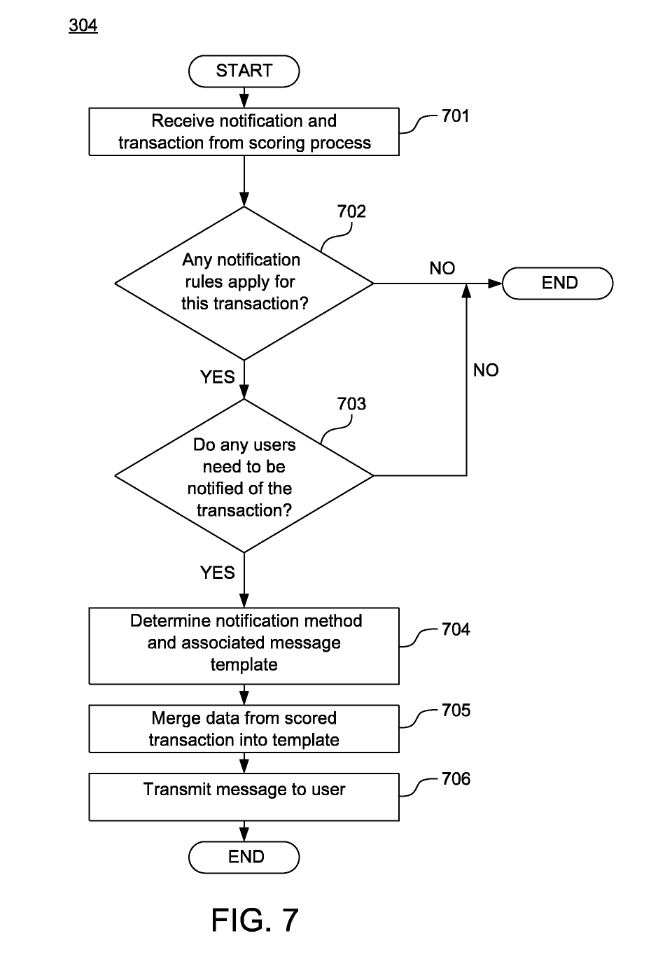

At block 304, and as described above in the context of FIG. 2, the alert module 225 generates and provides any alert(s) that may be determined to be warranted based on various criteria, such as the fuel-related score generated by the transaction scoring module 218, the fuel-related data received from the fuel-related data sources 101, and/or other criteria. An example procedure that may be executed at block 304 to generate and provide one or more alerts will be described below in connection with FIG. 7.

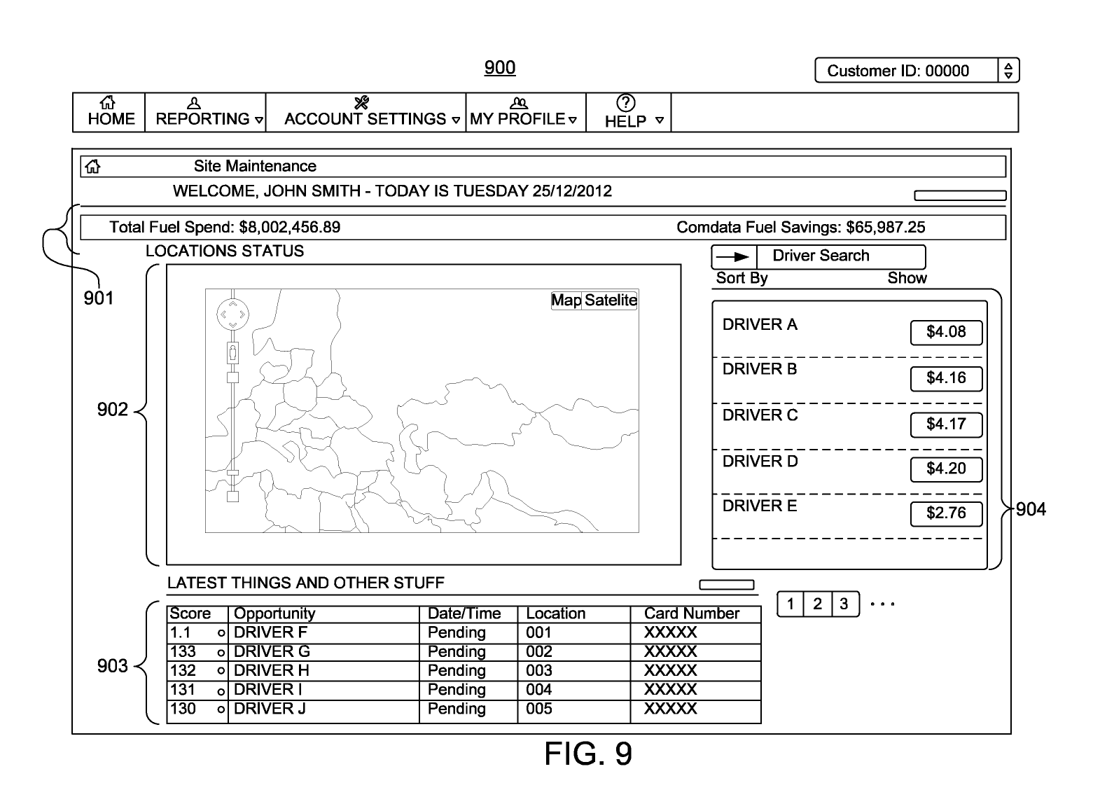

At block 305, and as described above in connection with FIG. 2, the console application 221 is presented via the user device 104 to enable the user to manage fuel costs based on various criteria and/or real-time or pseudo-real-time data, such as any computed fuel-related score(s) that may be stored in the console database 219. Example views and/or interfaces that may be provided via the console application 221 will be described below in connection with FIGS. 9 through 25.

In one example embodiment, fleet managers and purchase card administrators may use the console application 221 to set score thresholds to better control costs. Based on the score as well as proximity to a nearby service station offering a better score, fleet managers and purchase card administrators can deny fuel purchase transactions and can notify the driver of the location they should use to purchase fuel. In another example embodiment, a driver may use text messaging or a mobile application to request a shut off override by providing a reason. Requested exceptions may be logged and weighted against rules set by the corresponding fleet. If the exception passes, the driver may be permitted to use a fuel pump to partially or fully fuel their vehicle.

In another example embodiment herein, the console application 221 enables a fleet corporation and its fuel managers to easily set and track goals for their fleet operations. Goals and operational objectives may be set at the fleet, manager, and driver levels. By enabling fleet level goal hierarchies to be created a top down approach may be provided for viewing the fleet corporation as a whole. Cascading goals may be assigned to one or all managers or drivers in the fleet. Goal alignment may assist in cross-company adherence to cascaded goals. Manager goals may also cascade to all drivers downstream. Goals may be customized by setting targets for transaction score, fuel spend, and dollars saved. A goals management dashboard and analytics reporting system provide visibility regarding a trajectory towards a goal and at risk goals. As described below, notifications may be configured to help keep the entire organization on track.

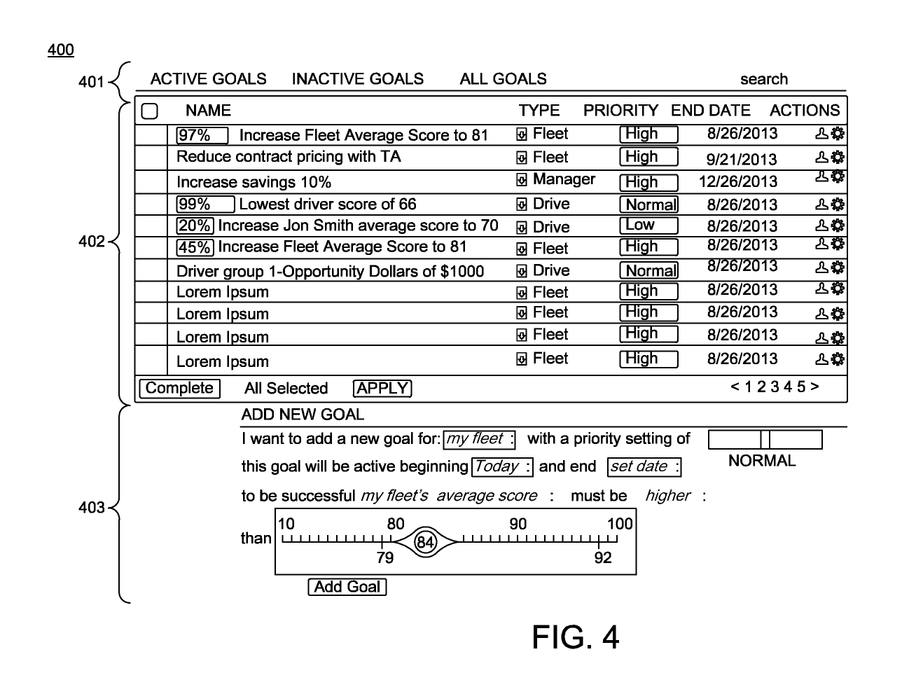

FIG. 4 shows a representative goals management dashboard interface 400, in accordance with an example embodiment herein. The goals management dashboard interface 400 includes a goal filtering portion 401, a goal list portion 402, and a goal adding portion 403. The goal filtering portion 401 enables a user to filter the type of goals (e.g., active goals, inactive goals, or all goals) that are displayed via the goal list portion 402. A list of goals and corresponding goal information (e.g., goal name, goal type, goal priority, goal end date, and/or the like) is displayed via the goal list portion 402. Under the actions column of the goal list portion 402 two icons are included—one icon that enables a user to share a goal with other users and one icon that enables a user configure or modify a goal. The goal adding portion 403 enables a user to input various parameters (e.g., a fleet name, a goal priority, a goal start date, a goal end date, goal scoring parameters or thresholds, and/or the like) to configure a new goal.

In accordance with another example embodiment herein, drivers and fleet managers are enabled, via a mobile application that may be executed on the user device 104, to access driver and vehicle statistics, routes, chain scores, and facility services. Utilizing vehicle and/or in-cab devices, data may be collected by the server 102 automatically or manually, providing visibility to vehicle idle times, distance traveled, average and real time speed, vehicle health, average miles per gallon, required fuel type(s), driver hours, etc. Drivers also may be enabled to easily rate stops on safety, parking, wait times, cleanliness, showers, and food quality. Drivers can be alerted on pricing, scoring, route changes, as well as road closures, low clearance, accident avoidance, traffic jams, and/or the like.

In some example aspects herein, the console application 221 uses route planning systems and takes into consideration goals, fleet specific chain pricing, and transaction scores to generate a suggested route. Route plans may be created by driver, destination, arrival deadline, daily max driver hours, chain preference settings, and score requirements. Routes may be displayed and updated in real-time or pseudo-real-time. Plans may be further refined by facility services, ratings, pump wait times, vehicle health, average miles per gallon, and/or the like.

Referring back to FIG. 3, at block 306, and as described above in connection with FIG. 2, the analytical reporting application 223 and/or the opportunity analyzer application 224 are presented via the user device 104 to enable the user to analyze and/or manage fuel costs based on various historical criteria, such as historical fuel-related scores retrieved from the data mart 222 database. Example views and/or interfaces that may be provided via the analytical reporting application 223 and/or the opportunity analyzer application 224 will be described below in connection with FIGS. 26 through 34.

Having described an exemplary procedure 300 for managing fuel costs, reference will be made to FIG. 5 to further describe an exemplary procedure for generating one or more fuel-related scores that, in one example embodiment, may be executed at block 303.

At block 501, and as described above in connection with FIG. 2, the transaction classification module 216 classifies the fuel transaction for which authorization was requested at block 301, based on various criteria, such as a geographical location from which the transaction request originated (sometimes referred to herein as geocoding).

At block 502, the alternative evaluation module 217 identifies alternative fuel providers that are located within a predetermined distance from the geographical area from which the transaction request originated (e.g., as determined at block 501).

At block 503, the transaction scoring module 218 computes discounted net prices based on discount pricing data stored in the discount pricing database 212. In particular, the transaction scoring module 218 computes discount net prices based on discount pricing data that describes any pricing discount(s) that have been prenegotiated between the customer (e.g., the truck driver who caused the transaction request to be submitted at block 301 and/or a trucking service provider (also referred to herein as a “fleet”) that employs the truck driver) and one or more merchants (e.g., the particular fuel provider location from which the transaction request originated as well as any nearby alternative fuel provider(s) identified at block 502). For any merchant that does not have any pricing discount negotiated with the customer, the transaction scoring module 218 computes a net price based on undiscounted pricing offered by the merchant.

At block 504, the transaction scoring module 218 retrieves from the customer account database 211 customer score component weighting preferences, if any, stored in association with the customer (i.e., the truck driver) who requested authorization (block 301) of the fuel purchase transaction. Weighting preferences enable users to set a weight, rank, and/or priority for each factor (e.g., ordering factors from least to most important) that is used in generating a score value. For example, certain customers may value security higher than fuel price and accordingly can select a higher weight, rank, and/or priority for high security as a weighting preference. In this example, the transaction scoring module 218 can use such a weighting preference to prioritize the identification of locations with higher security over locations with low fuel prices. Other weighting preferences can include merchant amenities, in another example.

At block 505, the transaction scoring module 218 retrieves from the customer account database 211 non-price-related scoring components, if any, stored in association with the customer (i.e., the truck driver) who requested authorization (block 301) of the fuel purchase transaction. For example, a customer may assign scores and/or weights to particular amenities provided by a fueling location, whether the fueling location offers cardless transactions, types of fuel offered at a fuel location, the proximity of the fuel location to a highway, and/or other non-price-related factors, to be factored into the score computed block 506 (described below). In this way, each fleet/customer may tailor the fuel-related score computation to suit their needs, by giving varying degrees of importance to different factors as they see fit.

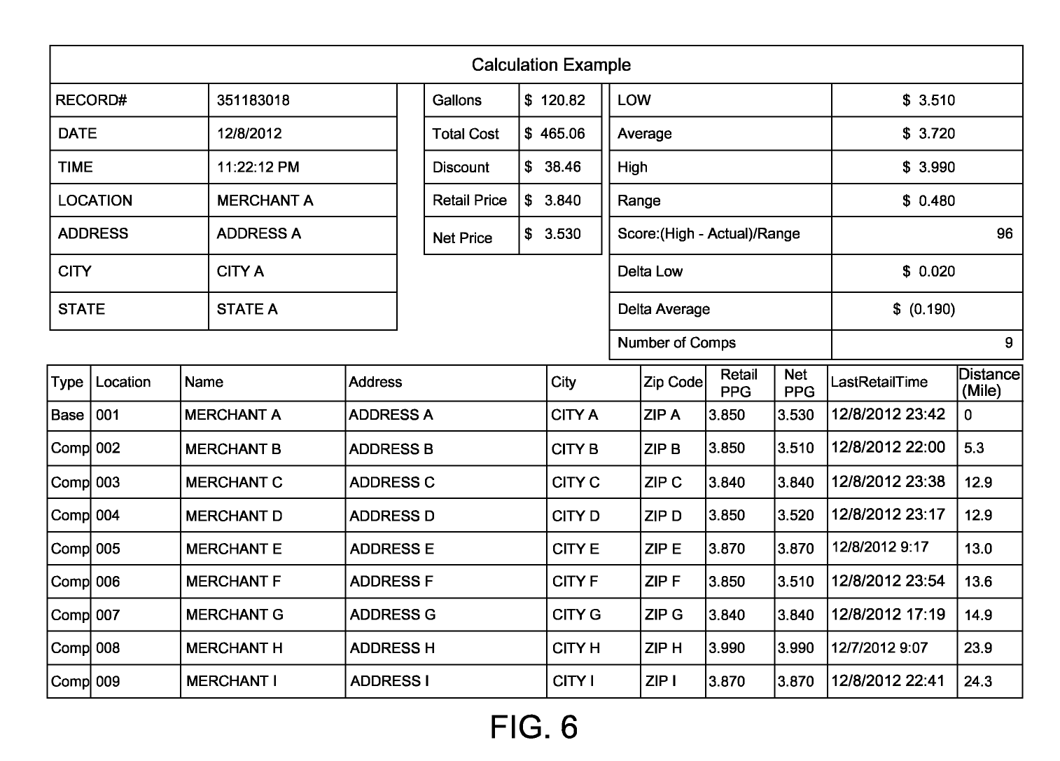

At block 506, the transaction scoring module 218 computes fuel-related scores for the fuel purchase transaction requested (block 301) by the truck driver for the particular fuel provider location identified at block 501 as well as for the possible alternative fuel purchase transactions at nearby fuel provider locations identified at block 502, taking into account (1) any pricing discounts identified at block 503, (2) any customer score component weighting preferences identified at block 504, and (3) any non-price-related scoring components identified at block 505. Exemplary data elements that may be employed at block 506 to compute fuel-related scores, as well as resulting computed fuel-related scores, are shown in FIG. 6.

In a top left portion of FIG. 6, various items of transaction information are shown. For example, a record key represents a unique identifier for a transaction received from card processing entity. Date and time fields indicate a date and time that the transaction occurred, respectively. A location field identifies a name of a location where the transaction occurred. Address, city, and state fields represent components of a physical address of the location where the transaction occurred.

In a top middle portion of FIG. 6, various items of purchase pricing information are shown. A gallons field indicates a total quantity of gallons of fuel purchased in connection with the transaction. A total cost field indicates a total transaction cost for the transaction. A discount field indicates a total discount amount available for the transaction. A retail price field indicates an original price per unit (e.g., gallon) before any discounts are applied (e.g., total cost/gallons). A net price field indicates a final price per unit after discounts are applied (e.g., (total cost−discount)/gallons).

In a top right portion of FIG. 6, various items of price-related statistical information are shown. For example, a low field indicates the lowest price per unit that is available within a highway segment or a radius of the transaction location. An average field indicates the average of all prices available within the highway segment or radius of the transaction location. A high field indicates the highest price available within the highway segment or radius of the transaction location. A range field indicates a price range that separates the highest price from the lowest price within the highway segment or radius of the transaction location (e.g., high−low). A score field indicates a pricing ratio of a difference between the high and net price (or actual price) compared to the range (e.g., (high−actual)/range). A delta low field indicates a difference in an amount between the net price and the low. A delta average field indicates a difference in an amount between the net price and the average. A number of comps field indicates a number of fueling options/locations (e.g., used for comparison purposes) within the highway segment or radius of the transaction location.

In a bottom portion of FIG. 6, various items of transaction information for a base transaction and comparison transactions are shown. For example, a type field indicates whether a transaction is either a base transaction or a comparison transaction. A location field includes a fueling location identifier that indicates where a transaction occurred. In one example, the fueling location identifiers may be derived from the merchant data 214 (FIG. 2). A name field identifies a name of a merchant location where a transaction occurred, which, in one example, may be derived from the merchant data 214. Address, city, and ZIP code fields represent components of a physical address of the location where a transaction occurs and, in one example, may be derived from the merchant data 214. A retail price per unit (e.g., price per gallon (PPG)) field indicates a retail price per unit before any discounts for a transaction and, in one example, may be derived from the transaction data 210. A net price per unit (e.g., PPG) field indicates a price per unit after discounts are applied and, in one example, may be derived from the discount pricing data 210. A last retail time field indicates a time of the last transaction for the corresponding merchant location and, in one example, may be derived from the transaction data 210. A distance (e.g., in miles) field indicates a distance between a location where a transaction occurred with respect to a location where the base transaction occurred.

Referring now back to FIG. 5, at block 507, the transaction scoring module 218 stores, in the scored transactions database 220 and/or the console database 219, the fuel-related scores computed at block 506, along with any other pertinent information, such as data relied upon in computing the fuel-related scores.

At block 508, the transaction scoring module 218 provides the fuel-related scores computed at block 506, along with any other pertinent information, such as data relied upon in computing the fuel-related scores, to the alert determination module 226 to begin an alerting procedure.

Reference will now be made to FIG. 7 to describe an exemplary fuel cost alerting procedure that, in some example embodiments herein, further represents aspects of the alerting procedure described above in connection with block 304 (FIG. 3) and/or block 508 (FIG. 5).

At block 701, the alert determination module 226 receives the fuel-related scores and any other pertinent information provided by the transaction scoring module 218 at block 508.

At block 702, the alert determination module 226 determines, based on predetermined rules stored in the alert rule database 228 and/or rules generated by the rule engine 227, whether any rules are applicable to the particular fuel transaction requested (block 301). In one example embodiment, alerts are triggered by checking a cumulative transaction score against rules for a particular user. Rules may include thresholds that, if exceeded/triggered, cause a user to receive a notification (e.g., per a user notification election). Example thresholds include, without limitation, a low/high score threshold, a score range threshold, a score combination threshold, and/or the like. Alerts may be delivered via to any suitable form of communication, such as, without limitation, e-mail (e.g., using simple mail transfer protocol (SMTP)), text message (e.g., short message service (SMS)), web interface, and/or the like. By way of example, a user profile setting a low score threshold at 75 would receive alerts by the chosen delivery procedure(s) if any transaction is processed with a score of less than 75.

If the alert determination module 226 determines at block 702 that no rules are applicable to the fuel transaction, then the procedure 304 ends. If, on the other hand, the alert determination module 226 determines at block 702 that one or more rules is applicable to the fuel transaction, then, at block 703, the alert determination module 226 determines, based on applying the one or more applicable rule(s) to various criteria (e.g., the fuel-related score generated by the transaction scoring module 218, the fuel-related data received from the fuel-related data sources 101, and/or other criteria) relating to the transaction, whether any fuel-related notification to a user is warranted for the transaction. If the alert determination module 226 determines at block 703 that no fuel-related notification to a user is warranted for the transaction, then the procedure 304 ends.

If, on the other hand, the alert determination module 226 determines at block 703 that one or more fuel-related notifications to a user is warranted for the transaction, then, at block 704, the alert determination module 226 identifies any notification preference(s) and/or notification templates stored in the alert rule database 228 that indicate how particular fuel-related notifications are to be provided. Example ways in which fuel-related notifications may be provided include, without limitation, an email communication, a short message service (SMS) communication, a pre-recorded telephone communication, and/or the like.

At block 705, the alert determination module 226 generates the one or more fuel-related notification(s) determined at block 703 to be warranted, in accordance with the one or more notification preference(s) and/or notification template(s) identified at block 704. In one example embodiment, the alert determination module 226 generates the fuel-related notification by merging data from one or more of the fuel-related scores computed at block 506 (FIG. 5) into a notification template identified at block 704.

At block 706, the alert determination module 226 forwards the one or more notification(s) generated at block 705 to the notification delivery 229 module, which, in turn, provides the fuel-related notification to a user in accordance with the one or more notification preference(s) and/or notification template(s) identified at block 704.

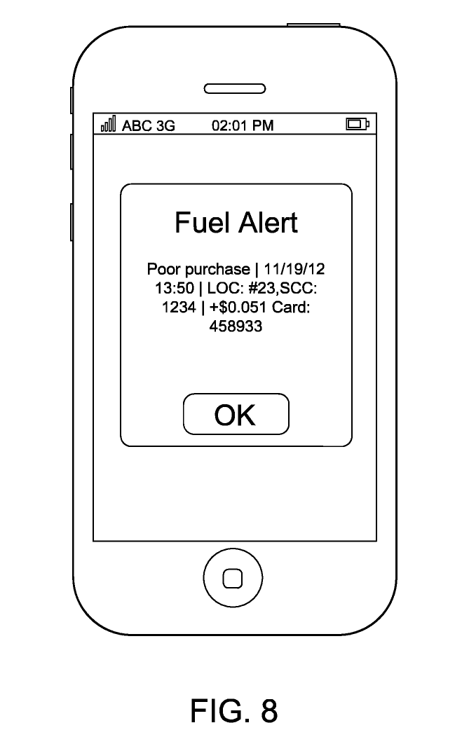

An exemplary fuel-related notification that may be provided at block 706 via the user device 104 (e.g., a mobile communication device) is shown in FIG. 8.

Having described an exemplary fuel cost alerting procedure, reference will now be made to FIGS. 9 through 25 to describe various exemplary interfaces that, as described above in connection with block 305 (FIG. 3), may be provided via the console application 221 (FIG. 2) executed by the user device 104 (FIG. 1), in accordance with some example embodiments herein.

FIG. 9 shows a representative fuel cost console interface 900, in accordance with an example embodiment herein. The exemplary interface 900 includes a fuel spend/savings portion 901, an interactive map portion 902, a latest things portion 903, and a driver status portion 904. In the fuel spend/savings portion 901, a total fuel spend and fuel savings for a particular time period (e.g., the last twenty-four hours) are indicated. In the latest things portion 903, specific opportunities are listed along with related scores, dates/times, locations, and card numbers. In the driver status portion 904, the statuses of various drivers are listed, along with fuel prices at which the drivers were charged in connection with recently purchased fuel transactions. In another example embodiment, a feature (not shown in FIG. 9) enabling searches for individual purchasers/drivers transaction activity is provided via the interface 900.

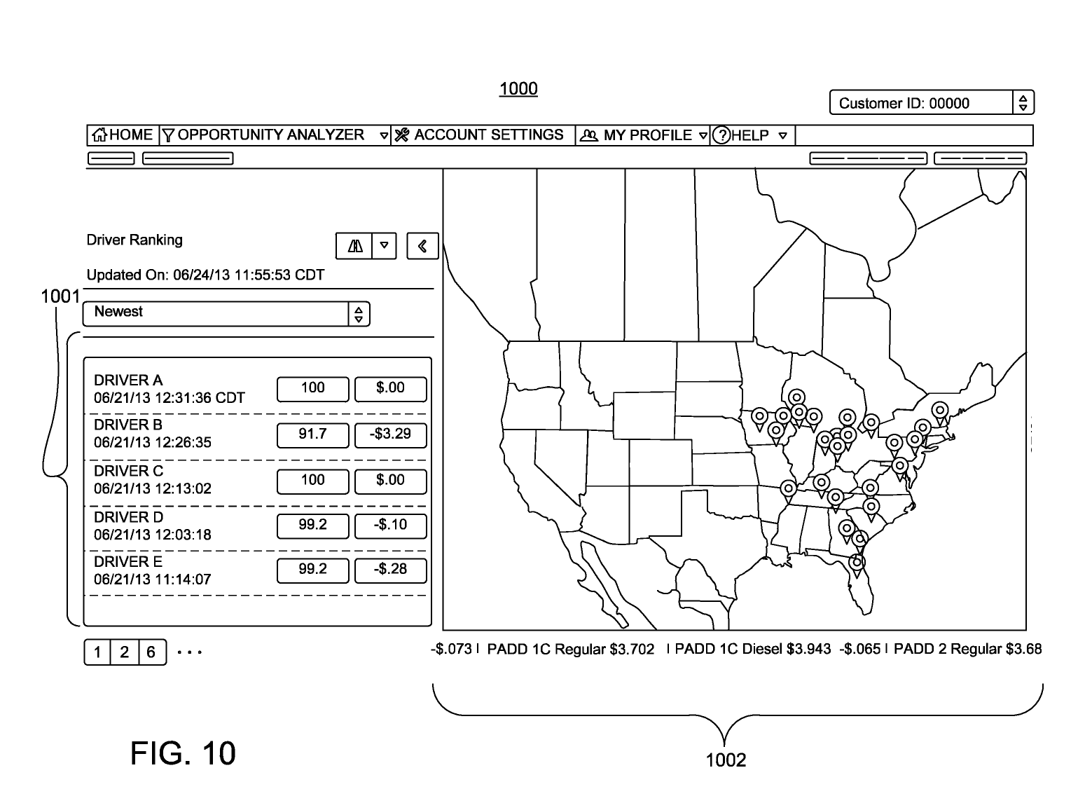

FIG. 10 shows another view of a representative fuel cost console interface 1000, in accordance with an example embodiment herein. The exemplary interface 1000 includes a driver ranking portion 1001, including a dropdown box that a user may interact with to cause a list of the newest drivers to be presented, along with their corresponding scores and fuel prices for recent fuel transactions. The driver ranking portion 1001 shows the average score for each driver for a given period of time and enables a user to rank transactions by score, price, driver, time, location, and/or the like. The list can be sorted by ascending/descending score and most recent transaction. The exemplary interface 1000 also includes an interactive map portion 1002, including markers that indicate locations of recent fuel purchase transactions. Individual or aggregated transactions data for individual locations or regions may be represented with each marker shown on the map portion 1002. Zooming in on the map portion 1002 enables markers to become more individualized. Zooming out on the map portion 1002 can cause the markers to aggregate transaction data. Each marker is selectable for further detail. Shown beneath the map is fuel market (e.g., wholesale/retail) and/or regional fuel pricing information (e.g., Petroleum Administration for Defense Districts (PADD)-related information).

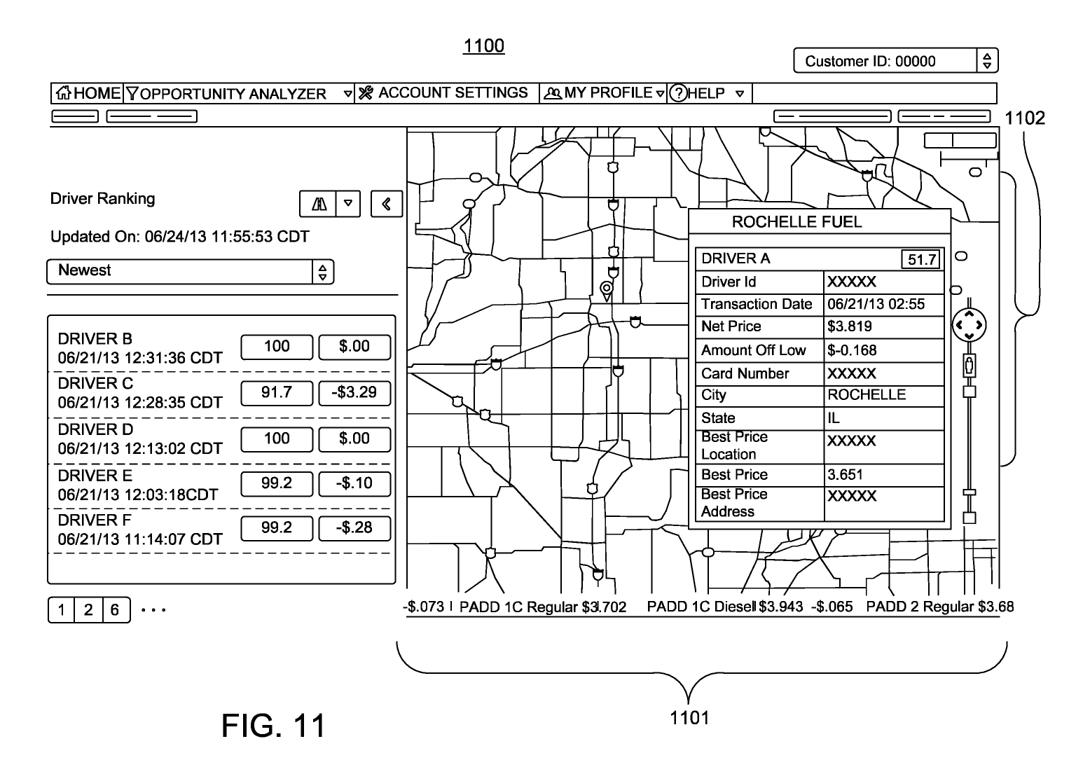

FIG. 11 shows a further view of a representative fuel cost console interface 1100, in accordance with an example embodiment herein. The exemplary interface 1100 includes an interactive map portion 1101 in which a detail pane 1102 that a user has launched shows details relating to a particular fuel transaction. The interface 1100 enables a user to access detailed information about a transaction at a particular location. A user can select a marker, such as one of the markers shown in FIG. 10, to access transaction- or location-specific information. In response to the user's selection, information relating to the specific map marker is displayed, as shown in the detail pane 1102. The information may include a location name, a driver name, a driver score, a driver identifier, a transaction date, a time, a net price, an amount off low (e.g., a difference between what the customer paid and the lowest price per gallon for fuel across all of the alternatives evaluated in establishing the score), a card number, merchant location information, a location name of the best alternative merchant (best price location), the best price at that alternative merchant, and location of the best alternative merchant.

In one example, the information shown in FIGS. 9 through 11 may be presented in real-time or pseudo-real-time as the transactions occur and can be refreshed either automatically or manually via user controls (e.g., refreshing or reloading a webpage). This facilitates management of fuel purchases, enabling users to contact drivers immediately to cause a change in the drivers' behavior before their purchasing pattern becomes a larger problem.

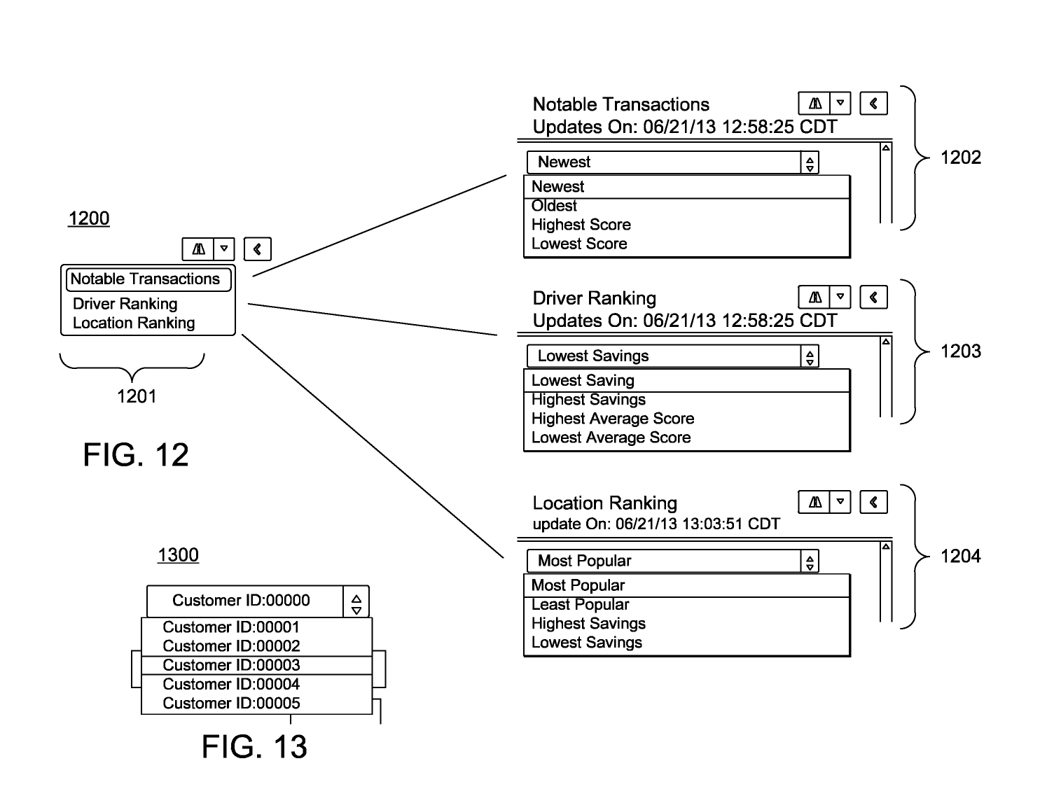

FIG. 12 shows exemplary interfaces 1200 navigation options that may be available via a fuel cost console interface, in accordance with an example embodiment herein. The exemplary interfaces 1200 include a dropdown box 1201 by which a user may select to view notable transactions, driver rankings, or location rankings Selecting notable transactions in the dropdown box 1201 causes a notable transactions pane 1202 to be presented, by which the user may select to view the newest notable transactions, the oldest notable transactions, the highest score notable transactions, or the lowest score notable transactions.

Selecting driver ranking in the dropdown box 1201 causes a driver ranking pane 1203 to be presented, by which the user may select to view drivers achieving the lowest savings, drivers achieving the highest savings, drivers achieving the highest average score, or drivers achieving the lowest average score.

Selecting location ranking in the dropdown box 1201 causes a location ranking pane 1204 to be presented, by which the user may select to view the most popular fueling locations, the least popular fueling locations, the fueling locations where the highest savings were realized, or the fueling locations where the lowest savings were realized.

FIG. 13 shows an exemplary dropdown box 1300 by which a user may select a particular customer, in accordance with an example embodiment herein. Dropdown box 1300 enables a user to select one or more specific customer identifiers they are interested in analyzing in the interface and show only transactions and data associated with the selected customer identifier(s). Alternatively, the option may be provided to select to view information for all customer identifiers.

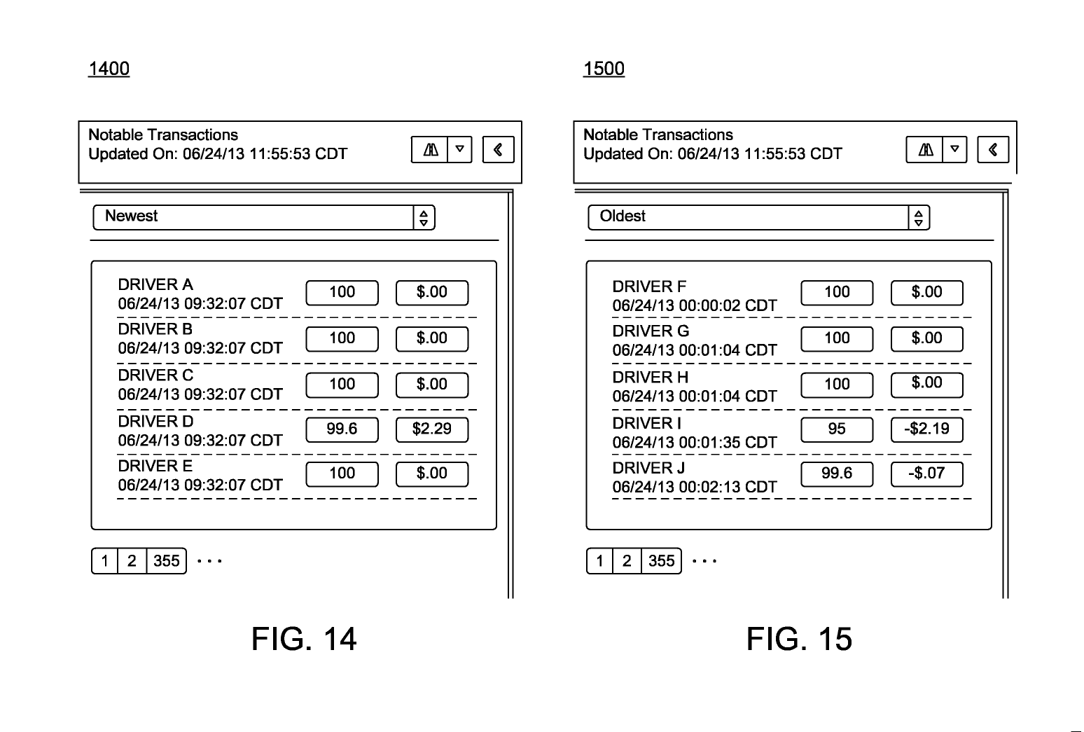

FIG. 14 is an exemplary notable transactions interface 1400 that may be presented via a fuel cost console interface to show information relating to new transactions, in accordance with an example embodiment herein.

FIG. 15 is an exemplary notable transactions interface 1500 that may be presented via a fuel cost console interface to show information relating to old transactions, in accordance with an example embodiment herein.

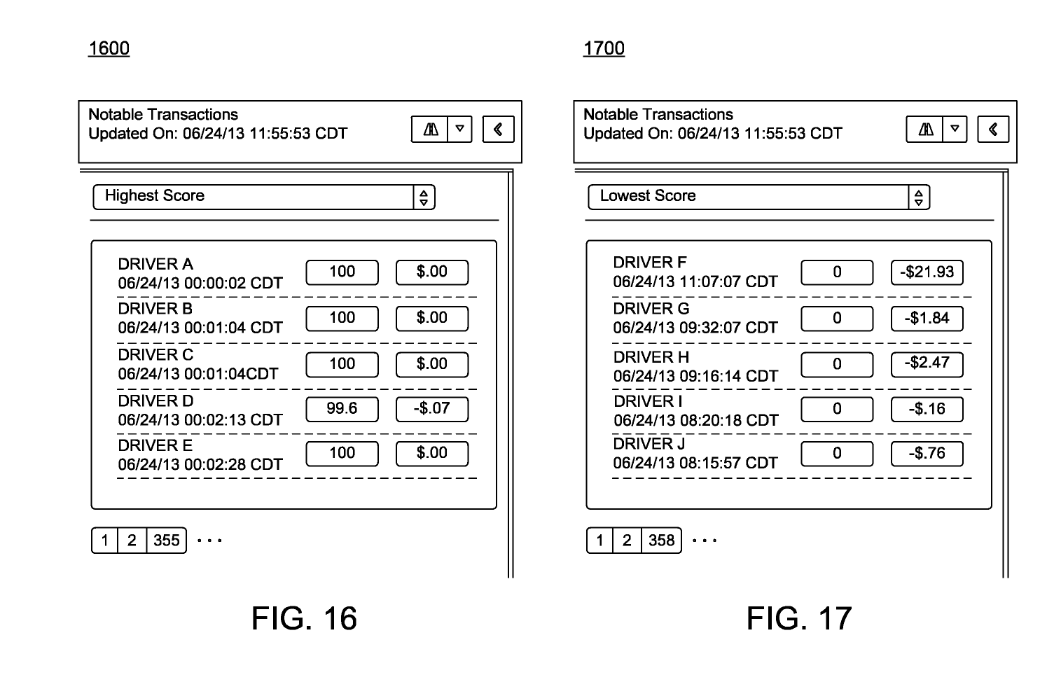

FIG. 16 is an exemplary notable transactions interface 1600 that may be presented via a fuel cost console interface to show information relating to high scoring transactions, in accordance with an example embodiment herein.

FIG. 17 is an exemplary notable transactions interface 1700 that may be presented via a fuel cost console interface to show information relating to low scoring transactions, in accordance with an example embodiment herein.

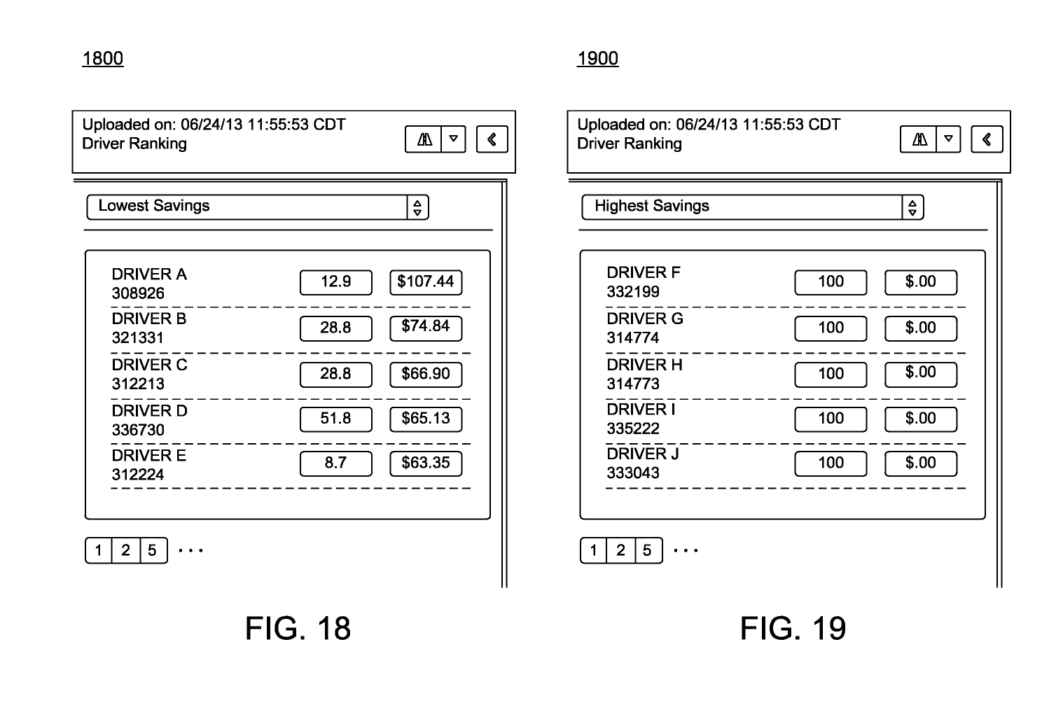

FIG. 18 is an exemplary driver ranking interface 1800 that may be presented via a fuel cost console interface to show information relating to low saving drivers, in accordance with an example embodiment herein.

FIG. 19 is an exemplary driver ranking interface 1900 that may be presented via a fuel cost console interface to show information relating to high saving drivers, in accordance with an example embodiment herein.

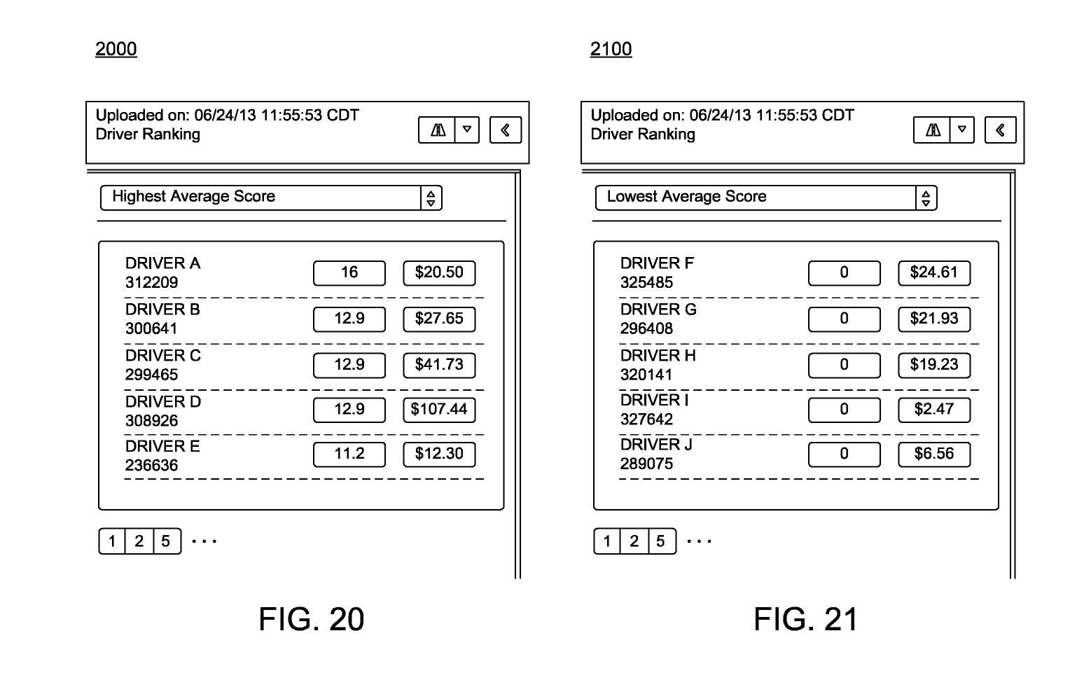

FIG. 20 is an exemplary driver ranking interface 2000 that may be presented via a fuel cost console interface to show information relating to high scoring drivers, in accordance with an example embodiment herein.

FIG. 21 is an exemplary driver ranking interface 2100 that may be presented via a fuel cost console interface to show information relating to low scoring drivers, in accordance with an example embodiment herein.

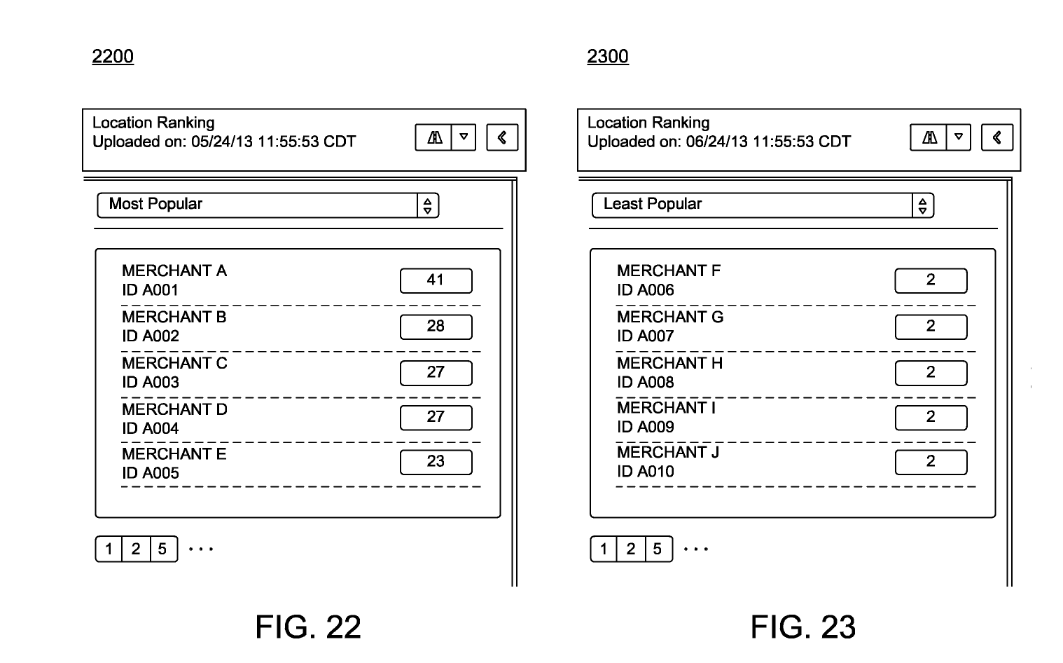

FIG. 22 is an exemplary location ranking interface 2200 that may be presented via a fuel cost console interface to show information relating to most popular fueling locations, in accordance with an example embodiment herein.

FIG. 23 is an exemplary location ranking interface 2300 that may be presented via a fuel cost console interface to show information relating to least popular fueling locations, in accordance with an example embodiment herein.

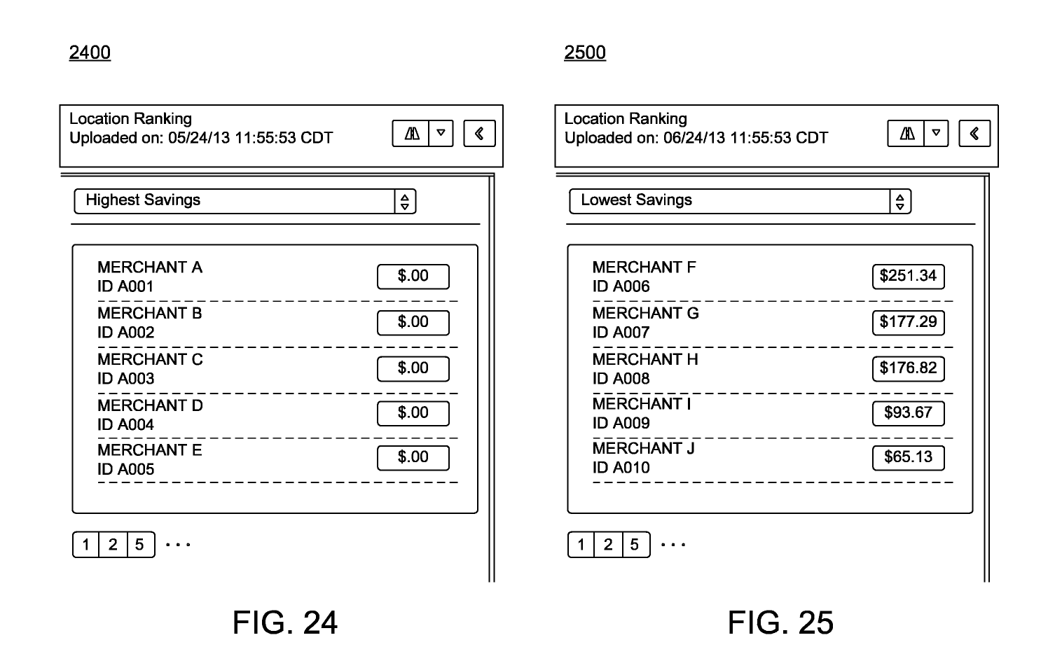

FIG. 24 is an exemplary location ranking interface 2400 that may be presented via a fuel cost console interface to show information relating to high savings fueling locations, in accordance with an example embodiment herein.

FIG. 25 is an exemplary location ranking interface 2500 that may be presented via a fuel cost console interface to show information relating to low savings fueling locations, in accordance with an example embodiment herein.

Having described various exemplary interfaces that may be provided via the console application 221 (FIG. 2), in accordance with some example embodiments herein, reference will now be made to FIGS. 26 through 34 to describe exemplary interfaces that may be provided via the analytical reporting application 223 and/or the opportunity analyzer application 224 (FIG. 2).

FIG. 26 shows a representative fuel cost analytics interface 2600, in accordance with an example embodiment herein. The interface 2600 includes a criteria portion 2601, where user may select an account, a date range and a view period (e.g., day, week, month, or year). The interface 2600 also includes a fuel score to fuel savings portion 2602, where an average score, an amount of opportunity dollars, and an amount of fuel spend are shown. A chart portion 2603 shows how fuel-related scores relate to opportunity dollar amounts. The interface 2600 also includes a fleet performance portion 2604, where amounts of driver alerts, gallons purchased, transactions completed, and best in class ranks are presented. A top opportunities portion 2605 shows opportunities based on driver, state, or trucking service provider chain (i.e., fleet).

As shown in portion 2602, opportunity dollars represents a dollar amount that could be saved if a fleet had a higher average score (e.g., if drivers purchased fuel at locations with lower prices). Opportunity dollars is a reference measure to the actual average score. Fuel spend represents a dollar amount that has been spent on fuel transactions for the time frame selected in criteria portion 2601. A user may adjust the average score by clicking the plus/minus signs shown in portion 2602 to cause a corresponding score designation on the chart portion 2603 to be adjusted. Alternatively, the user may drag an icon on the chart portion 2603 to adjust the score. The opportunity dollars will increase as the score is incremented to reflect the amount of dollars that could be saved if the higher score is obtained as compared to the actual score. Similarly, the opportunity dollars will decrease as the score is decremented. The fuel spend will adjust in a similar, although not necessarily identical, manner as the score is incremented or decremented. The user may also hover a data selection tool (such as a mouse) over each point on the graph to see the opportunity dollars associated with each score value below.

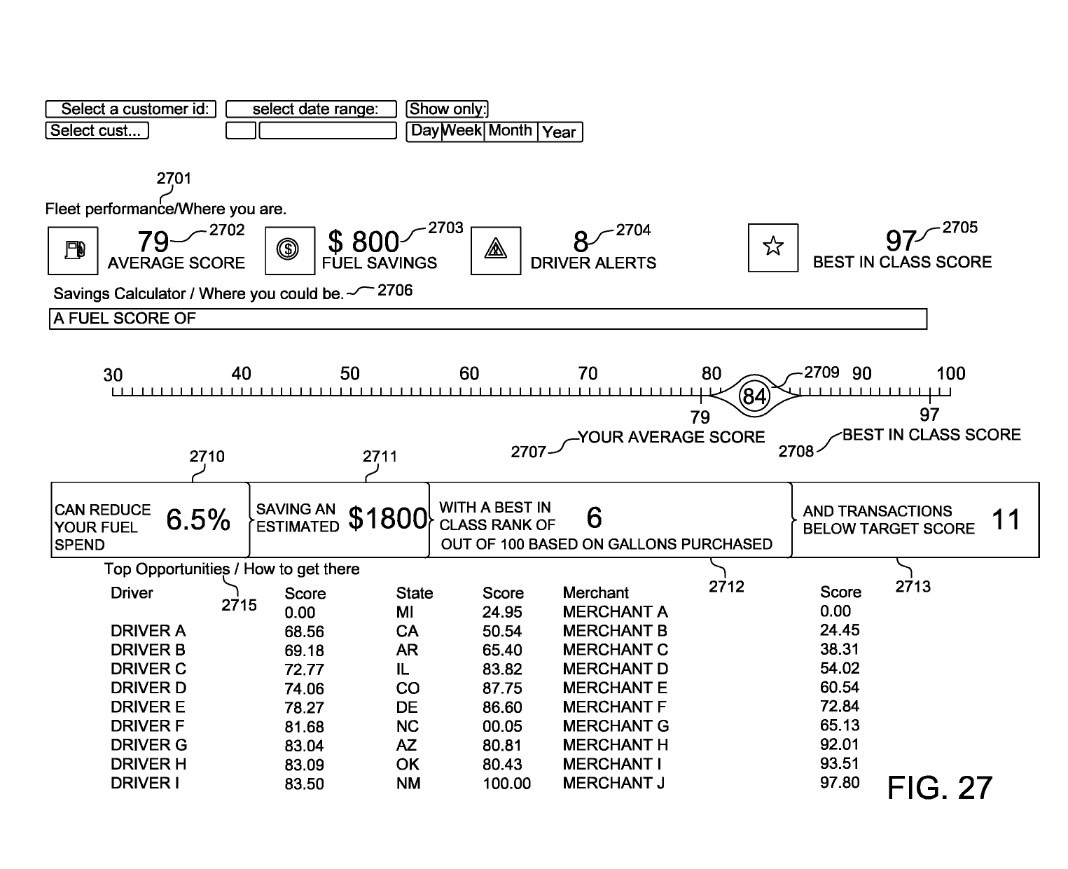

FIG. 27 shows another representative fuel cost analytics interface includes, in accordance with an example embodiment herein. The interface includes a fleet performance portion 2701 in which an average score 2702, an amount of fuel savings 2703, a number of driver alerts 2704, and a best in class score 2705 are shown. In one example, each of these four items 2702 through 2705 are further selectable to view additional information related thereto, such as, the specifics of the driver alerts or the underlying scores to derive the average score and fuel savings.

In a savings calculator portion 2706, a numerical scale is shown on which an average score 2707, a best in class score 2708, and a target score marker 2709 are indicated. In one example embodiment, the savings calculator portion 2706 functions in a manner similar to the chart portion 2603 of FIG. 26. The marker 2709 is a slide-able marker that can be used to provide information in a “what if” analysis.

Shown beneath the numerical scale is information relating to the target score, for example, information that would be applicable if the selected target score indicated by the marker 2709 is realized. For example, a percentage 2710 by which fuel spend may be reduced is shown. Also shown are an amount of estimated savings 2711, a best in class rank 2712, and a number of transactions below the target score 2713. In one example embodiment, upon initiation, the slide-able marker 2709 is set to start on the fleets average score 2707, resulting in (1) the fuel spend reduction indicating 0%; (2) the estimated savings 2711 indicating an amount currently saved based on the average score 2707; (3) the best in class rank indicating the fleet's current best in class rank (1-100) based on their average fuel score 2707 relative to the fleets they are being compared to; and (4) the number of transaction below target score 2713 indicating the number of transactions in which the user would be alerted if their threshold was set to the referenced score value. The user may click on the scale or drag the marker 2709 to an alternative point on the scale. As the slide-able marker 2709 score changes, the four categories below 2710 through 2713 adjust accordingly. As the score decreases, the fuel spend reduction percentage 2710 increases, and savings 2711, best in class rank 2712, and transactions below target score 2713 decrease.

Also included in the interface is a top opportunities portion 2715 which includes lists of driver scores, location scores, and merchant scores. This enables a user to highlight the drivers, states and chains that are the highest and lowest performers, and to analyze what would yield the highest impact on a user's score. Each of these sections can be selected to access additional detail and supporting data.

Although not shown in FIGS. 26 and 27, additional portions may be added to the fuel cost analytics interfaces of FIGS. 26 and 27, including, for example, information differentiating between fuel types purchased, more detailed customer class comparisons, and/or additional analysis of fuel purchase activity (e.g., fuel transaction activity over time, score improvement over time, and/or the financial benefit over time of improving the user's score by a specific amount). Such information can be depicted in various ways including, numerically or graphically.

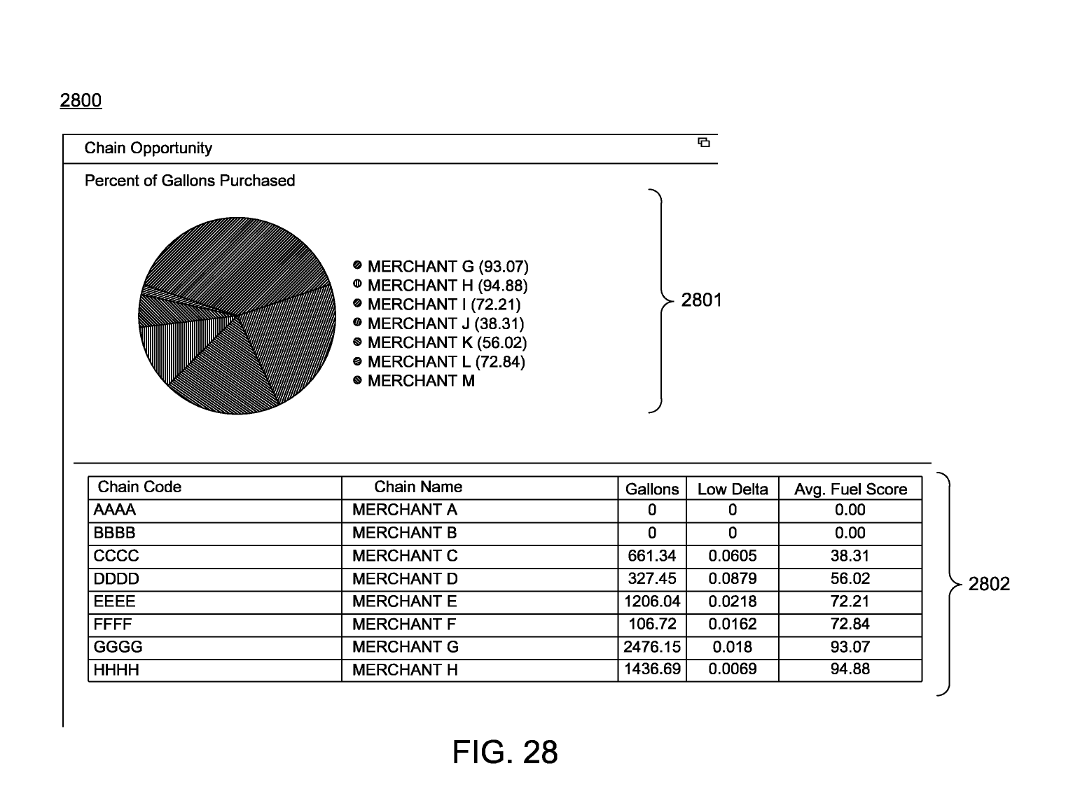

FIG. 28 shows an exemplary view of an interface 2800 that may be presented via the analytical reporting application 223 and/or the opportunity analyzer application 224 (FIG. 2) to illustrate opportunities relating to trucking service provider chains (i.e., fleets), in accordance with an example embodiment herein. A percent of gallons purchased portion 2801 includes a pie chart showing the percentage of gallons purchased by specific fleets. A table portion 2802 shows, for each fleet, the number of gallons purchased, the low delta and the average fuel score realized.

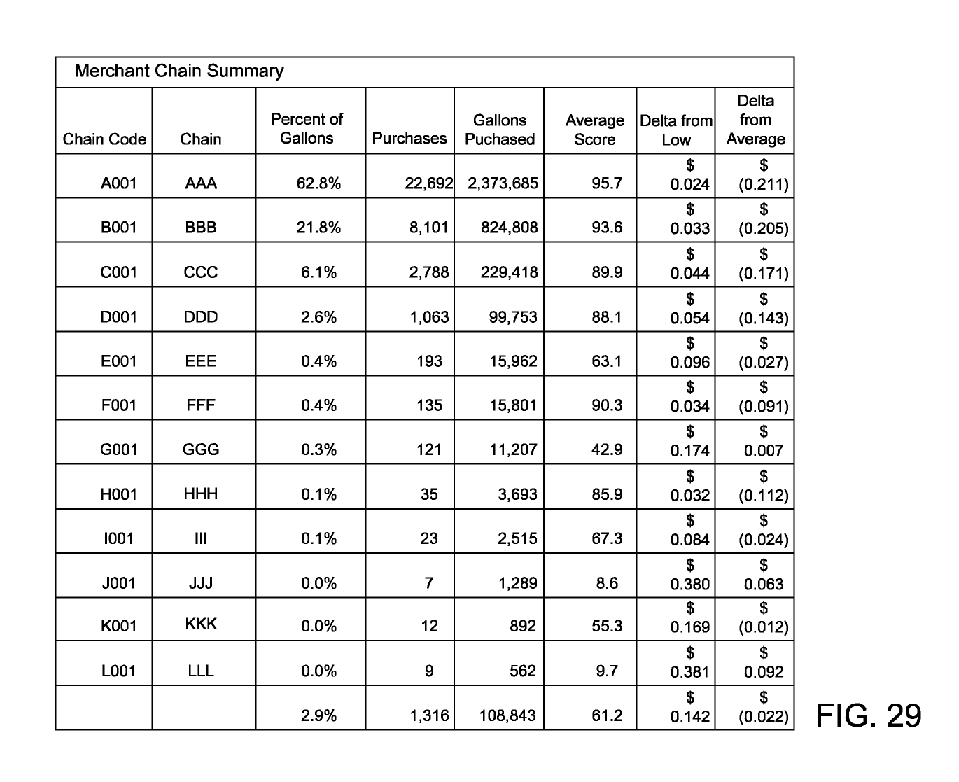

FIG. 29 shows an exemplary chart that may be presented via the analytical reporting application 223 and/or the opportunity analyzer application 224 (FIG. 2) to illustrate opportunities relating to trucking service provider chains, in accordance with an example embodiment herein. In addition to the items shown in FIG. 28, the chart in FIG. 29 shows, for each chain, a percentage of gallons, a number of purchases, and values representing a delta from a low value and a delta from a high value.

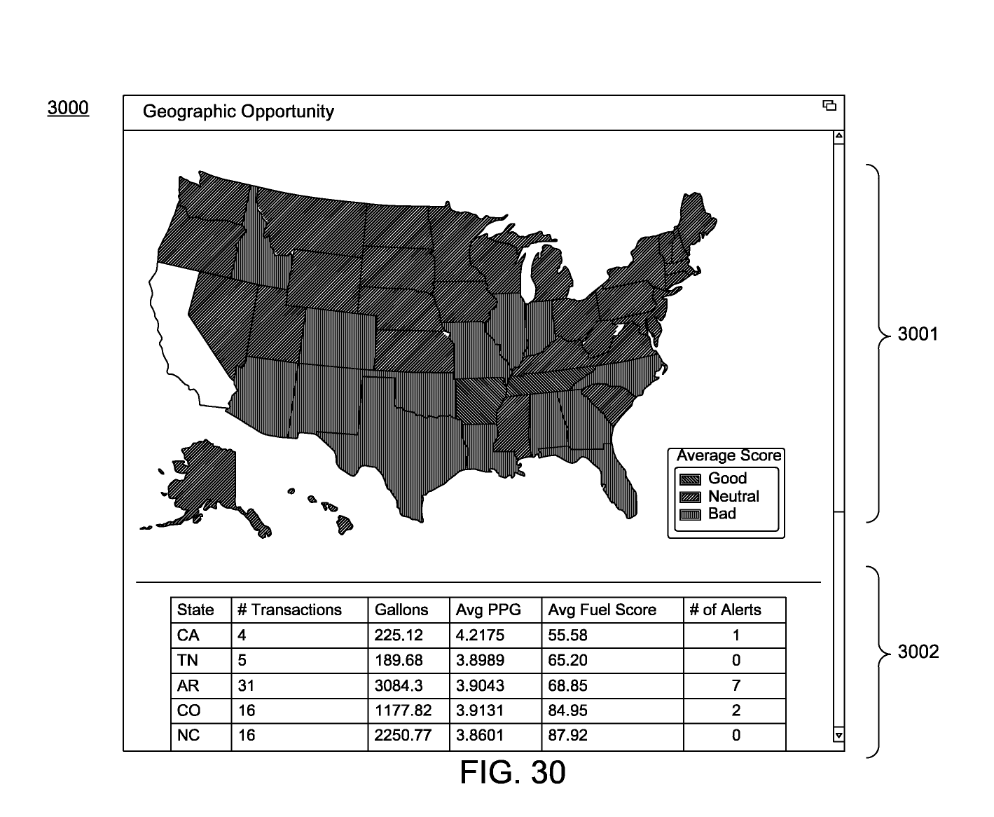

FIG. 30 shows an exemplary view of an interface 3000 that may be presented via the analytical reporting application 223 and/or the opportunity analyzer application 224 (FIG. 2) to illustrate geography-related opportunities, in accordance with an example embodiment herein. The interface 3000 includes a map portion 3001 that indicates whether good, neutral, or bad average fuel-related scores have been realized in each state, for example, using shading. A chart portion 3002 shows, for each state, a number of transactions, a number of gallons of fuel purchased, an average price per gallon realized, an average fuel score, and a number of alerts.

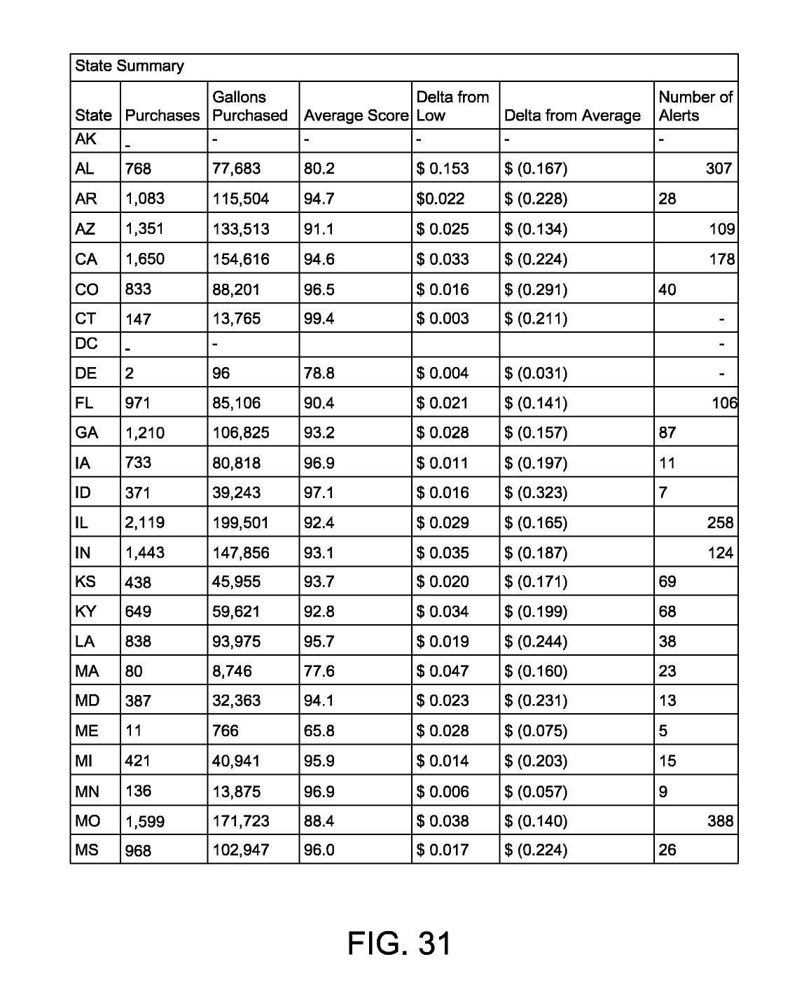

FIG. 31 shows an exemplary chart that may be presented via the analytical reporting application 223 and/or the opportunity analyzer application 224 (FIG. 2) to illustrate geography-related opportunities, in accordance with an example embodiment herein. In addition to the items shown in FIG. 30, the chart in FIG. 31 shows, for each state, values representing a delta from a low amount and a delta from an average amount.

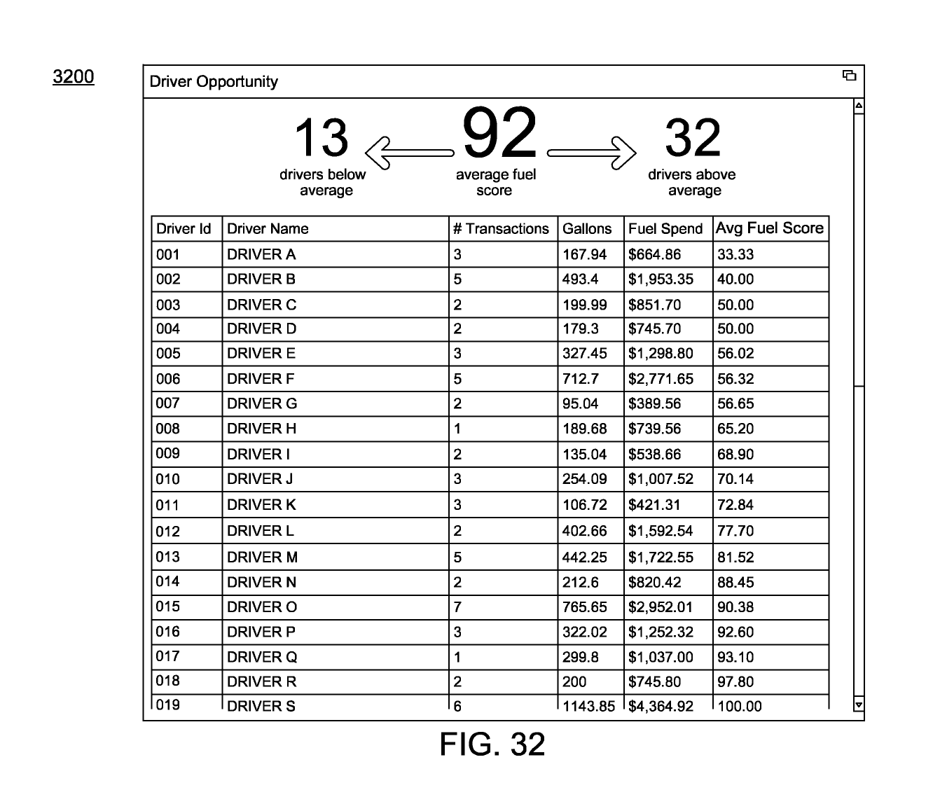

FIG. 32 shows an exemplary view of an interface 3200 that may be presented via the analytical reporting application 223 and/or the opportunity analyzer application 224 (FIG. 2) to illustrate driver-related opportunities, in accordance with an example embodiment herein. The interface 3200 includes a table that indicates, for each driver, a driver identifier, a number of transactions, a number of gallons of fuel purchased, an amount spent on fuel, and an average fuel-related score.

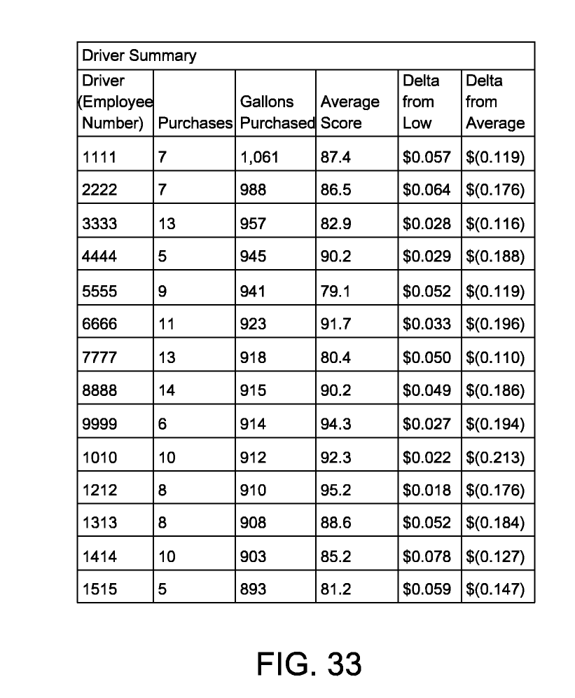

FIG. 33 shows an exemplary chart that may be presented via the analytical reporting application 223 and/or the opportunity analyzer application 224 (FIG. 2) to illustrate driver-related opportunities to illustrate driver-related opportunities, in accordance with an example embodiment herein. In addition to the items shown in FIG. 32, the chart in FIG. 33 shows, for each driver, values representing a delta from a low amount and a delta from an average amount.

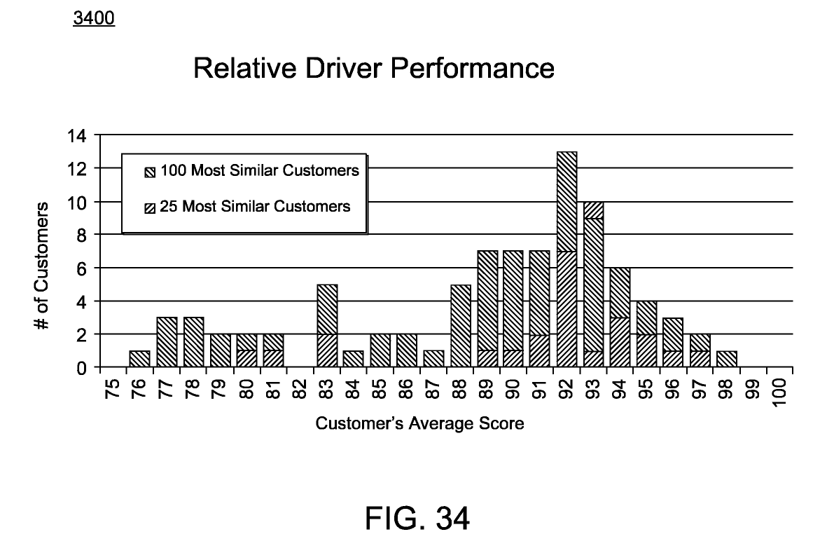

FIG. 34 shows an exemplary chart 3400 that may be presented via the analytical reporting application 223 and/or the opportunity analyzer application 224 (FIG. 2) to illustrate relative driver performance, in accordance with an example embodiment herein. In particular, the chart 3400 is a histogram showing average scores along its horizontal axis and numbers of customers along its vertical axis. The chart 3400 indicates, for each average score shown on the horizontal axis, a corresponding number of customers that (1) have been categorized as being similar (for example, based on having one or more similar purchasing attribute(s), such as purchasing volume) and (2) have achieved the particular average score. In the example chart 3400 of FIG. 34, two groups of customers are shown—a first group of 25 customers that have been categorized as being mutually similar and a second group of 100 customers that have been categorized as being mutually similar. In one example, such similar customers are grouped and compared as a best in class benchmark.

As may be appreciated in view of the foregoing, systems, methods, and computer readable media are provided for managing fuel costs. The various example aspects herein enable cost savings to be realized by enabling real-time decisioning and control over fuel purchasing behavior. Improved accountability and visibility are provided, thus helping customers understand available purchasing opportunities.

### IV. Example Computer-Readable Medium Implementations

The example embodiments described above, such as, for example, the systems and procedures depicted in or discussed in connection with FIGS. 1 through 34 or any part or function thereof, may be implemented by using hardware, software or a combination of the two. The implementation may be in one or more computers or other processing systems. While manipulations performed by these example embodiments may have been referred to in terms commonly associated with mental operations performed by a human operator, no human operator is needed to perform any of the operations described herein. In other words, the operations may be completely implemented with machine operations. Useful machines for performing the operation of the example embodiments presented herein include general-purpose digital computers or similar devices.

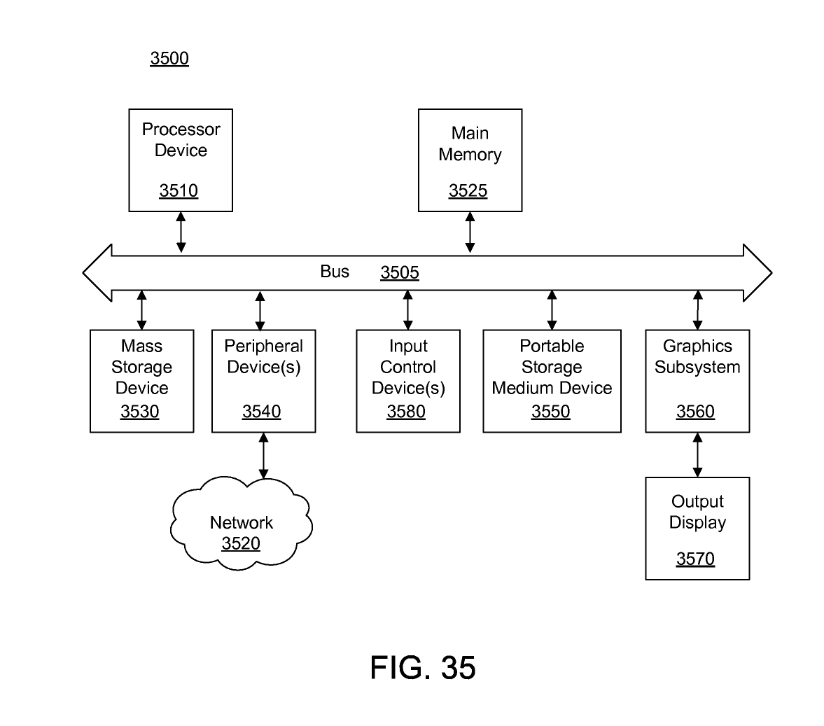

FIG. 35 is a block diagram of a general and/or special purpose computer 3500 that may be employed in accordance with various example embodiments herein. The computer 3500 may be, for example, a user device, a user computer, a client computer, and/or a server computer, among other things.

The computer 3500 may include without limitation a processor device 3510, a main memory 3525, and an interconnect bus 3505. The processor device 3510 may include without limitation a single microprocessor, or may include a plurality of microprocessors for configuring the computer 3500 as a multi-processor system. The main memory 3525 stores, among other things, instructions and/or data for execution by the processor device 3510. The main memory 3525 may include banks of dynamic random access memory (DRAM), as well as cache memory.

The computer 3500 may further include a mass storage device 3530, peripheral device(s) 3540, portable storage medium device(s) 3550, input control device(s) 3580, a graphics subsystem 3560, and/or an output display 3570. For explanatory purposes, all components in the computer 3500 are shown in FIG. 35 as being coupled via the bus 3505. However, the computer 3500 is not so limited. Devices of the computer 3500 may be coupled via one or more data transport means. For example, the processor device 3510 and/or the main memory 3525 may be coupled via a local microprocessor bus. The mass storage device 3530, peripheral device(s) 3540, portable storage medium device(s) 3550, and/or graphics subsystem 3560 may be coupled via one or more input/output (I/O) buses. The mass storage device 3530 may be a nonvolatile storage device for storing data and/or instructions for use by the processor device 3510. The mass storage device 3530 may be implemented, for example, with a magnetic disk drive or an optical disk drive. In a software embodiment, the mass storage device 3530 is configured for loading contents of the mass storage device 3530 into the main memory 3525.

The portable storage medium device 3550 operates in conjunction with a nonvolatile portable storage medium, such as, for example, a compact disc read only memory (CD-ROM), to input and output data and code to and from the computer 3500. In some embodiments, the software for storing an internal identifier in metadata may be stored on a portable storage medium, and may be inputted into the computer 3500 via the portable storage medium device 3550. The peripheral device(s) 3540 may include any type of computer support device, such as, for example, an input/output (I/O) interface configured to add additional functionality to the computer 3500. For example, the peripheral device(s) 3540 may include a network interface card for interfacing the computer 3500 with a network 3520.

The input control device(s) 3580 provide a portion of the user interface for a user of the computer 3500. The input control device(s) 3580 may include a keypad and/or a cursor control device. The keypad may be configured for inputting alphanumeric characters and/or other key information. The cursor control device may include, for example, a mouse, a trackball, a stylus, and/or cursor direction keys. In order to display textual and graphical information, the computer 3500 may include the graphics subsystem 3560 and the output display 3570. The output display 3570 may include a cathode ray tube (CRT) display and/or a liquid crystal display (LCD). The graphics subsystem 3560 receives textual and graphical information, and processes the information for output to the output display 3570.

Each component of the computer 3500 may represent a broad category of a computer component of a general and/or special purpose computer. Components of the computer 3500 are not limited to the specific implementations provided here.

Portions of the example embodiments of the invention may be conveniently implemented by using a conventional general-purpose computer, a specialized digital computer and/or a microprocessor programmed according to the teachings of the present disclosure, as is apparent to those skilled in the computer art. Appropriate software coding may readily be prepared by skilled programmers based on the teachings of the present disclosure.

Some embodiments may also be implemented by the preparation of application-specific integrated circuits, field programmable gate arrays, or by interconnecting an appropriate network of conventional component circuits.

Some embodiments include a computer program product. The computer program product may be a storage medium or media having instructions stored thereon or therein which can be used to control, or cause, a computer to perform any of the procedures of the example embodiments of the invention. The storage medium may include without limitation a floppy disk, a mini disk, an optical disc, a Blu-Ray Disc, a DVD, a CD-ROM, a micro-drive, a magneto-optical disk, a ROM, a RAM, an EPROM, an EEPROM, a DRAM, a VRAM, a flash memory, a flash card, a magnetic card, an optical card, nanosystems, a molecular memory integrated circuit, a RAID, remote data storage/archive/warehousing, and/or any other type of device suitable for storing instructions and/or data.

Stored on any one of the computer readable medium or media, some implementations include software for controlling both the hardware of the general and/or special computer or microprocessor, and for enabling the computer or microprocessor to interact with a human user or other mechanism utilizing the results of the example embodiments of the invention. Such software may include without limitation device drivers, operating systems, and user applications. Ultimately, such computer readable media further includes software for performing example aspects of the invention, as described above.

Included in the programming and/or software of the general and/or special purpose computer or microprocessor are software modules for implementing the procedures described above.

While various example embodiments of the invention have been described above, it should be understood that they have been presented by way of example, and not limitation. It is apparent to persons skilled in the relevant art(s) that various changes in form and detail can be made therein. Thus, the invention should not be limited by any of the above described example embodiments, but should be defined only in accordance with the following claims and their equivalents.

In addition, it should be understood that the figures are presented for example purposes only. The architecture of the example embodiments presented herein is sufficiently flexible and configurable, such that it may be utilized and navigated in ways other than that shown in the accompanying figures.

Further, the purpose of the Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the example embodiments presented herein in any way. It is also to be understood that the procedures recited in the claims need not be performed in the order presented.

We claim:

1. A method for managing fuel costs, the method comprising steps of:
receiving, from a fuel-related data source via a communications network, fuel-related data including a request for authorization of a fuel transaction;
computing a fuel-related score based on the fuel-related data and a predetermined weighting factor; and
presenting, through a user interface, the fuel-related score.

2. The method of claim 1, wherein the computing the fuel-related score includes:
identifying, based on the fuel-related data, a geographical location of the fuel transaction;
identifying, based on the geographical location of the fuel transaction, a plurality of nearby alternative fuel provider locations;
retrieving, from a database, fuel-related data associated with the plurality of nearby alternative fuel provider locations; and
computing the fuel-related score based on the fuel-related data associated with the plurality of nearby alternative fuel provider locations.

3. The method of claim 1, wherein the predetermined weighting factor includes any one or a combination of a price-related weighting factor and a non-price-related weighting factor, and wherein the predetermined weighting factor is one of a plurality of predetermined weighting factors stored in association with a corresponding fleet.

4. The method of claim 1, further comprising a step of generating, based on the fuel-related score and a predetermined alert rule stored in an alert rule database, a fuel-related notification for the fuel transaction, the predetermined alert rule being one of a plurality of predetermined alert rules stored in association with a plurality of fleets, correspondingly.

5. The method of claim 1, further comprising a step of presenting, via the user interface, any one or a combination of a list of notable transactions, a ranking of a plurality of drivers, and a ranking of a plurality of fuel provider locations.

6. The method of claim 1, further comprising steps of:
aggregating, from a plurality of fuel-related data sources via the communications network, a plurality of fuel-related data associated with any one or a combination of a plurality of fuel providers, a plurality of geographical locations, and a plurality of drivers; and
presenting, through the user interface, a comparison of the aggregated fuel-related data.

7. The method of claim 1, further comprising:
matching, in a database, the transaction to a fleet and a merchant; and
retrieving, from the database, pricing agreement information associated with the fleet and the merchant, wherein the computing the fuel-related score includes computing the fuel-related score based on the pricing agreement information.

8. A system for managing fuel costs, the system comprising at least one processor configured to:
receive, from a fuel-related data source via a communications network, fuel-related data including a request for authorization of a fuel transaction;
compute a fuel-related score based on the fuel-related data and a predetermined weighting factor; and
present, through a user interface, the fuel-related score.

9. The system of claim 8, wherein the at least one processor is further configured to compute the fuel-related score by:
identifying, based on the fuel-related data, a geographical location of the fuel transaction;
identifying, based on the geographical location of the fuel transaction, a plurality of nearby alternative fuel provider locations;
retrieving, from a database, fuel-related data associated with the plurality of nearby alternative fuel provider locations; and
computing the fuel-related score based on the fuel-related data associated with the plurality of nearby alternative fuel provider locations.

10. The system of claim 8, wherein the predetermined weighting factor includes any one or a combination of a price-related weighting factor and a non-price-related weighting factor, and wherein the predetermined weighting factor is one of a plurality of predetermined weighting factors stored in a memory in association with a corresponding fleet.

11. The system of claim 8, wherein the at least one processor is further configured to generate, based on the fuel-related score and a predetermined alert rule stored in an alert rule database, a fuel-related notification for the fuel transaction, the predetermined alert rule being one of a plurality of predetermined alert rules stored in a memory in association with a plurality of fleets, correspondingly.

12. The system of claim 8, wherein the at least one processor is further configured to present, through the user interface, any one or a combination of a list of notable transactions, a ranking of a plurality of drivers, and a ranking of a plurality of fuel provider locations.

13. The system of claim 8, wherein the at least one processor is further configured to:
aggregate, from a plurality of fuel-related data sources via the communications network, a plurality of fuel-related data associated with any one or a combination of a plurality of fuel providers, a plurality of geographical locations, and a plurality of drivers; and
present, through the user interface, a comparison of the aggregated fuel-related data.

14. The system of claim 8, wherein the at least one processor is further configured to:
match, in a database, the transaction to a fleet and a merchant; and
retrieve, from the database, pricing agreement information associated with the fleet and the merchant, wherein the computing the fuel-related score includes computing the fuel-related score based on the pricing agreement information.

15. A non-transitory computer-readable medium having stored thereon sequences of instructions that, when executed by a computer processor, cause the computer processor to:
receive, from a fuel-related data source via a communications network, fuel-related data including a request for authorization of a fuel transaction;
compute a fuel-related score based on the fuel-related data and a predetermined weighting factor; and
present, through a user interface, the fuel-related score.

16. The non-transitory computer-readable medium of claim 15, wherein the computing of the fuel-related score includes:
identifying, based on the fuel-related data, a geographical location of the fuel transaction;
identifying, based on the geographical location of the fuel transaction, a plurality of nearby alternative fuel provider locations;
retrieving, from a database, fuel-related data associated with the plurality of nearby alternative fuel provider locations; and
computing the fuel-related score based on the fuel-related data associated with the plurality of nearby alternative fuel provider locations.

17. The non-transitory computer-readable medium of claim 15, wherein the predetermined weighting factor includes any one or a combination of a price-related weighting factor and a non-price-related weighting factor, and wherein the predetermined weighting factor is one of a plurality of predetermined weighting factors stored in association with a corresponding fleet.

18. The non-transitory computer-readable medium of claim 15, wherein, when executed by the computer processor, the sequences of instructions further cause the computer processor to generate, based on the fuel-related score and a predetermined alert rule stored in an alert rule database, a fuel-related notification for the fuel transaction, the predetermined alert rule being one of a plurality of predetermined alert rules stored in association with a plurality of fleets, correspondingly.

19. The non-transitory computer-readable medium of claim 15, wherein, when executed by the computer processor, the sequences of instructions further cause the computer processor to present, through the user interface, any one or a combination of a list of notable transactions, a ranking of a plurality of drivers, and a ranking of a plurality of fuel provider locations.

20. The non-transitory computer-readable medium of claim 15, wherein, when executed by the computer processor, the sequences of instructions further cause the computer processor to:
aggregate, from a plurality of fuel-related data sources via the communications network, a plurality of fuel-related data associated with any one or a combination of a plurality of fuel providers, a plurality of geographical locations, and a plurality of drivers; and
present, through the user interface, a comparison of the aggregated fuel-related data.

21. The non-transitory computer-readable medium of claim 15, wherein, when executed by the computer processor, the sequences of instructions further cause the computer processor to:
match, in a database, the transaction to a fleet and a merchant; and
retrieve, from the database, pricing agreement information associated with the fleet and the merchant, wherein the fuel-related score is computed based on the pricing agreement information.
